(19) United States
(12) Patent Application Publication
(10) Pub. No.: US 2012/0058405 A1
(43) Pub. Date: Mar. 8, 2012

(54) CAVITATION ASSISTED SONOCHEMICAL HYDROGEN PRODUCTION SYSTEM

(76) Inventors: James A. Kirchoff, Tucson, AZ (US); Jose L. Marques, Scarsdale, NY (US); Francis A. Nottke, Oro Valley, AZ (US); Randolph E. Seligmann, Tucson, AZ (US); Peter D. Vasquez, Tucson, AZ (US); Robert Koeneman, Tucson, AZ (US); Jennifer Jeong, Tucson, AZ (US)

(21) Appl. No.: 13/170,115

(22) Filed: Jun. 27, 2011

Related U.S. Application Data
(63) Continuation-in-part of application No. 12/166,979, filed on Jul. 2, 2008.
(60) Provisional application No. 61/450,569, filed on Mar. 8, 2011.

(51) Int. Cl. H01M 8/06; H02K 7/18; C25B 9/08

(52) U.S. Cl. 429/422; 204/273; 290/1 R

(57) ABSTRACT

Apparatus for producing hydrogen gas comprise a container adapted to contain an aqueous electrolyte solution containing hydrogen, at least one first electrode, wherein the at least one first electrode is adapted to be in contact with a solution, at least one second electrode, wherein the at least one second electrode is adapted to be in contact with a solution, and wherein the at least one first electrode is a cylindrically-shaped cathode and the at least one second electrode is a cylindrically-shaped hollow anode capable of accommodating the cylindrically-shaped cathode within it, and wherein the cylindrically-shaped cathode is located along the central axis of the cylindrically-shaped hollow anode. Also included in this embodiment of the invention is at least a first acoustic transducer per cathode capable of causing cavitation in a solution, the at least one first transducer transmitting substantially along each cathode's axis; a power supply wherein power is supplied to the electrodes and transducers; a wave form generator for imposing a wave or other function on the power to the transducers; and a gas-liquid separation and capturing device.

### CROSS REFERENCE TO RELATED APPLICATIONS

This application is a continuation-in-part of U.S. Ser. No. 12/166,979 filed Jul. 2, 2008, pending, and to which priority is claimed. This application also claims priority to U.S. Provisional Application No. 61/450,569, filed Mar. 8, 2011. Both documents are incorporated herein by reference in their entirety.

### FIELD OF THE INVENTION

The present invention generally relates to efficient generation of hydrogen and more specifically to in-situ hydrogen generation.

### BACKGROUND OF THE INVENTION

Water is composed of two parts hydrogen and one part oxygen by mass or volume. Decomposed by any means, two moles of water will produce one mole of oxygen gas (02) and two moles of hydrogen gas (H₂) at a given input of energy E1. When combined together through any means, hydrogen and oxygen react to form water, releasing a given output of energy E2. By all known principles of physics and chemistry, E1>E2 and thus by thermodynamics the process is not favored in direct action. For hydrogen to be useful as an energy source and economical to use, a means must be created to either reduce the dissociation energy of water, or provide energy in some other fashion in the process, for example with catalytic enhancement, or all the above.

Hydrogen can be manufactured by a variety of means (including, but not limited to chemical, electrical, thermal, radiolysis, etc.) from a variety of chemical substances (including, but not limited to, water, hydrocarbons, plants, rocks, etc.). In the present invention water is used as the hydrogen source and a catalytic combination of electrolysis and cavitation is used to generate the hydrogen. The method of cavitation may be by a variety of means (acoustical, hydrodynamic inertial, non-inertial, mechanical, electromagnetic, etc.), or any combination thereof.

Hydrogen, being the most abundant element on earth as well as in the Universe, holds particular promise as a fuel source, both on earth as well as in space. Hydrogen can power homes and factories, transportation modes (planes, trains, and vehicles). Thus, hydrogen can serve to eliminate carbon fuels completely in the electrical cycle, thus bringing about a net subtraction by the contribution of anthropomorphic processes to terrestrial climate change. There are four significant “hurdles” cited by numerous reviews to the use of hydrogen. Each is noted as follows.

1. Production-How to produce massive amounts of hydrogen in an efficient, safe, environmentally ‘friendly’ fashion.

2. Storage-How to store the low density, flammable gas.

3. Distribution-Hydrogen, being difficult to store, is thus difficult to transport.

4. Use-How can hydrogen be used is a bigger hurdle in light of the prior two items.

Accordingly what is needed is a method and system to overcome the problems encountered in the prior art and to provide an economical method and apparatus to produce hydrogen.

### SUMMARY OF THE INVENTION

A method and an apparatus to generate hydrogen gas as H₂ from a hydrogen containing liquid such as water. In one embodiment, the structure is a electrolytic cell configured with catalytic enhancements to maximize the volume and mass of hydrogen produced, and minimize the energy input, thus minimizing cost of operation. This device is particularly configured to enhance catalytically the decomposition of water and the formation of hydrogen gas by: 1) the container apparatus configuration of electric and magnetic fields; 2) the use of sonochemistry and cavitation; and 3) the use of applicable solutes and solvents in the device that change the pH, ionic state, and the chemical potential of the device solution.

The cavitation may be generated by a variety of means including but not limited to, acoustic energy, hydrodynamic (inertial, non-inertial), mechanical, electromagnetic energy, etc., or any combination thereof.

There are four significant “hurdles” cited by numerous reviews to the use of hydrogen. Each is noted as follows.

1. Production-How to produce massive amounts of hydrogen in an efficient, safe, environmentally ‘friendly’ fashion. This patent is capable of producing hydrogen from water, and by any fashion in its recombination with oxygen to reform water, producing no pollution whatsoever and returning water back to its original form.

2. Storage-How to store the low density, flammable gas. This patent eliminates the need for storage, by creating a scalable process to generate hydrogen from water in-situ wherever it is needed. It thus eliminates the need for dangerous, costly, and hazardous storage and transport issues.

3. Distribution-Hydrogen, being difficult to store, is thus difficult to transport. Again, this patent eliminates the need for storage and thus transport, by creating a scalable process to generate hydrogen from water in-situ wherever it is needed. There is no need for dangerous, costly, and hazardous storage, distribution, and transport issues.

4. Use-How can hydrogen be used is a bigger hurdle in light of the prior two items. With the elimination of those two items, the relative cost of the use of fuel cells becomes economical even to the middle class. Without the need for refueling, or by minimizing the need for refueling, the ability to use fuel cells will become ubiquitous to modern life.

A method and apparatus of producing hydrogen is disclosed comprising applying an electrical current to flow through an aqueous solution. Cavitation is generated within the aqueous solution, where the cavitation lowers an amount of energy required to break chemical bonds of said aqueous solution.

The foregoing and other features and advantages of the present invention will be apparent from the following more particular description of the preferred embodiments of the invention, as illustrated in the accompanying drawings.

Additional embodiments of the invention are directed to an apparatus for producing hydrogen gas comprising a container adapted to contain an aqueous electrolyte solution containing hydrogen, at least one first electrode, wherein the at least one first electrode is adapted to be in contact with a solution, at least one second electrode, wherein the at least one second electrode is adapted to be in contact with a solution, and wherein the at least one first electrode is a cylindrically-shaped cathode and the at least one second electrode is a cylindrically-shaped hollow anode capable of accommodating is the cylindrically-shaped cathode within it, and wherein the cylindrically-shaped cathode is located along the central axis of the cylindrically-shaped hollow anode. Also included in this embodiment of the invention is at least a first acoustic transducer per cathode capable of causing cavitation in a solution, the at least one first transducer transmitting substantially along each cathode's axis; a power supply wherein power is supplied to the electrodes and transducers; a wave form generator for imposing a wave or other function on the power to the transducers; and a gas-liquid separation and capturing device.

Another embodiment of the invention additionally comprises at least a second acoustic transducer per anode and wherein the first and second acoustic transducers are capable of causing cavitation in an aqueous solution, said first transducer transmitting substantially along the cathodic axis, and said second transducer transmitting in a substantially orthogonal direction to the first transducer. The first transducer may transmit at an acoustic frequency of about 38 kHz and the second transducer may transmit at about 76 kHz.

Another embodiment of the invention includes a gas-liquid separation and capturing device that may be selected from the group consisting of a tube, a membrane filter, a diffusive evaporator, differential pressure and channeling solution flow. If the separation device includes a tube, then the tube has a different dielectric than that of the surrounding solution and is located between the anode and cathode. The tube may also surround the cathode and contain and guide gas bubbles to the gas separation and capturing device. The tube may also have a gas-permeable polymer membrane filter disposed within its length. Another embodiment of a gas-liquid separation device is a hollow fiber membrane filter. The filter is of the two-phase, counter-current design whereby a liquid is admitted at a first proximal end, and a sweep gas enters a series of parallel, interconnected gas-permeable hollow fiber membranes at a second, distal end. The dissolved gases in the liquid permeate the fibers and are swept up in the sweep gas. Another embodiment of the gas-liquid separation device comprises an expansion tank.

Another embodiment of the invention is directed to the above apparatus in combination with an aqueous electrolyte solution that comprises an effective amount of dissolved noble gas, iodide salt or an iodate salt, and one or more organic acids.

Another embodiment of the invention is directed to the apparatus wherein a wave form is superimposed on the transducer power, and a preferred function is a sine wave. In the embodiments of the invention where two orthogonally-directed transducers transmit into the cell, the individual waveforms from the first and second transducers collide in the region between the cathode and anode.

Another embodiment of the invention is directed to a cathode and anode that are arranged in pairs. A further embodiment includes more than one cathode may be matched with a single anode.

Another embodiment of the invention additionally comprises an electrolyte recirculation circuit whereby the electrolyte may be circulated using a fluid pump between the individual cells of a multi-cell unit. The recirculation circuit may also include a nozzle for directing electrolyte fluid towards the cathode, and an expansion tank or pressure blow-off valve for separating gas from liquid.

Another embodiment of the invention is directed to a system for generating electricity comprising the hydrogen generating apparatus in combination with one of an electrical generator, a fuel cell, and a hydrogen-burning internal combustion engine.

### BRIEF DESCRIPTION OF THE DRAWINGS

FIG. 1 is a diagram of a first embodiment of a hydrogen production system according to the present invention.

FIG. 2 is a diagram of a second embodiment of a hydrogen production system according to the present invention

FIG. 3 is a diagram of a conical funnel member of FIG. 2.

FIG. 4 is a diagram of a third embodiment of a hydrogen production system according to the present invention

FIG. 5 is a diagram of a first cavitation subsystem according to the present invention.

FIG. 6 is a diagram of a second cavitation subsystem according to the present invention.

FIG. 7 is a diagram of the major factors affecting hydrogen production.

FIG. 8 is a corner perspective of a computer-aided drawing of a single-cell sonoelectrochemical apparatus of the fourth embodiment.

FIG. 9 is a similar drawing taken from an elevation and facing the transverse transducer housing, with the gas collection tube, anode and bottom transducer housing made partially transparent.

FIG. 10 is a similar drawing taken from an elevation and rotated 90 degrees from FIG. 9.

FIG. 11 is an exploded view of the apparatus of FIGS. 8-10.

FIG. 12 is a graph of the hydrogen data produced using this embodiment.

FIG. 13 is a computer-aided drawing of a fifth embodiment of the invention. The drawing is shown with the tank and external box partially transparent so that the interior components are visible.

FIG. 14 is similar to FIG. 13 except the tank is not shown.

FIG. 15 is an exploded version of FIG. 14.

FIG. 16 is a computer-aided drawing of a six-cell embodiment of the invention shown partially disassembled from a corner view.

FIG. 17 is a similar computer-aided drawing but rotated approximately 180 degrees to show the back of the apparatus.

FIG. 18 is a computer aided line drawing of the gas separation and collection apparatus.

FIG. 19 is the same drawing as FIG. 18 but sectioned to show only two of the six filter units.

FIG. 20 is a computer-aided section drawing of the membrane/filter unit 760.

FIG. 21 is an exploded view of FIG. 20.

FIG. 22 is a computer-aided section drawing of the manifold.

FIG. 23 is an exploded view of FIG. 22.

FIGS. 24A-K are various electrode design motifs that come within the teachings of the invention.

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

In this patent the following definitions apply when these words are used:

Cavitation—Cavitation is the phenomenon of formation (irregardless of mechanism) of vapor bubbles in a fluid, in the region where the pressure of the fluid falls below its vapor pressure. Cavitation can be divided into two classes of behavior: inertial (or transient) cavitation, and non-inertial cavitation. Inertial cavitation is the process where a void or bubble in a liquid rapidly collapses, producing a shock wave. Non-inertial cavitation is the process where a bubble in a fluid is forced to oscillate in size or shape due to some form of energy (such as acoustic fields) input.

Acoustic Energy—For the purposes of this patent, ultrasonic acoustic energy refers to those frequencies from 16 kHz up to and including 2 mHz. “Power ultrasound” is commonly understood to include the frequency range of from 20 kHz to 100 kHz which is where cavitation occurs. Above 1000 kHz ultrasound is useful primarily for clinical imaging. Also for the purposes of this patent, acoustic energy, as well as any radiation of any frequency or wavelength in the electromagnetic spectrum, may be employed as a single frequency (wavelength) or any frequency combination thereof (as a discrete sum, difference, harmonics, sub-harmonics, overtones, series, etc.).

The term “extractor” is used interchangeably with “apparatus” to indicate the hydrogen production sonoelectrochemical cell embodiments described herein.

“Electrolysis” as it is used herein refers to Applicants' general protocol for producing hydrogen, but use of the term is not an admission that the process is equivalent to the conventionally understood term. In point of fact, Applicants have demonstrated herein that the hydrogen is produced by a sonoelectrochemical process, and not that of pure electrolysis. However, the term “electrolysis” is sometimes used to refer in shorthand manner to the sonoelectrochemical hydrogen production process developed hereunder.

The term “extractor” is used interchangeably with “apparatus” to indicate the hydrogen production cell embodiments described herein.

The following examples are illustrations of the embodiments of the inventions discussed herein, and should not be applied so as to limit the appended claims in any manner.

### First Embodiment of Hydrogen Production System

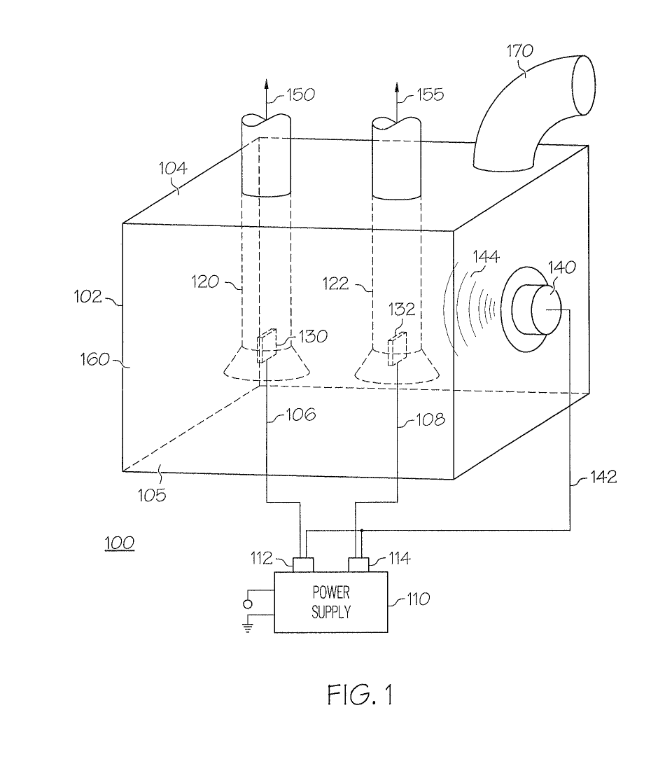

FIG. 1 is a cross sectional side view of the hydrogen production system 100 according to the present invention. Hydrogen production system 100 consists of a container apparatus 102 in the fashion of an electrolytic cell capable of storing a volume of a solution 160. Solution 160 is comprised of a solvent and solute. The solvent is preferably water or another aqueous solution containing hydrogen. The solute is a chemical compound capable of carrying an electrical charge i.e. an electrolyte. The sides of container apparatus 102 are preferably non-electrically conductive. Two electrically-conductive pieces 130 and 132 are held above the bottom member 105 of container apparatus 120 by supporting members 106 and 108, respectively. The electrically-conductive piece 130 is connected to the negative terminal 112 of power supply 110. Thus, the electrically-conductive piece 130 is a cathode. Likewise, the electrically conductive piece 132 is connected to the positive terminal 114 of power supply 110. Thus, the electrically-conductive piece 132 is an anode. A hollow, cylindrical tube 120 is connected to and passes though top member 104 of container apparatus 102. The bottom of tube 120 is flared outward and positioned so that the bottom of tube 120 is below the bottom of cathode 130 but not touching bottom member 105 of container apparatus 102. Likewise, a hollow, cylindrical tube 122 is connected to and passes through top member 104 of container apparatus 102. The bottom of tube 122 is flared outward and positioned so that the bottom of tube 122 is below the bottom of anode 132 but not touching bottom member 105 of container apparatus 102. Finally, a transducer 140 is connected to one side of container apparatus 102. Wires 142 connect transducer 140 to power supply 110.

As previously mentioned, power supply 110 causes cathode 130 to be negatively charged and anode 132 to be positively charged. As a result, an electrical current is created between cathode 130 and anode 132. The electrical current electrolyzes solution 160 and causes hydrogen to form around cathode 130 and oxygen to form around anode 132. Tube 120 funnels the hydrogen out of container apparatus 102 for use further use (shown by arrow 150), such as to provide fuel for hydrogen fuel cells or to directly power an engine. Likewise tube 122 funnels the oxygen out of container apparatus 102 (shown by arrow 155). As solution 160 is electrolyzed and the constituent gases are removed from the system 100, additional solution can be added through an inlet 170.

Transducer 140 produces acoustic energy waves 144 which transmit through and cause cavitation in solution 160. This cavitation decreases the energy required to break the chemical bonds of solution 160. As a result, in the presence of cavitation, a greater amount of hydrogen is produced at cathode 130 at a given voltage than in the absence of cavitation. Alternatively, in the presence of cavitation, the same amount of hydrogen is produced at cathode 130 at a lower voltage than in the absence of cavitation.

Hydrogen production system 100 is designed to be portable. In one embodiment, hydrogen production system 100 is sized approximately 8″ in length by 8″ in width by 8″ in height so that it can fit as an engine component in a vehicle. However, it is clear to one skilled in the art that hydrogen production system 100 and its components can be scaled larger or smaller without affecting the spirit and scope of the present invention. Likewise, it is clear to one skilled in the art that hydrogen production system 100 and its components can take on many different shapes without affecting the spirit and scope of the present invention. FIG. 1 shows one embodiment of the present invention where container apparatus 102 is shaped to allow maximum transmittal of sound waves 144 though solution 160. Finally, it is clear to one skilled in the art that any number of transducers 140 may be placed at various locations on container apparatus 102 and used to produce acoustic energy waves 144 in order to maximize the creation of cavitation within solution 160.

### Second Embodiment of Hydrogen Production System

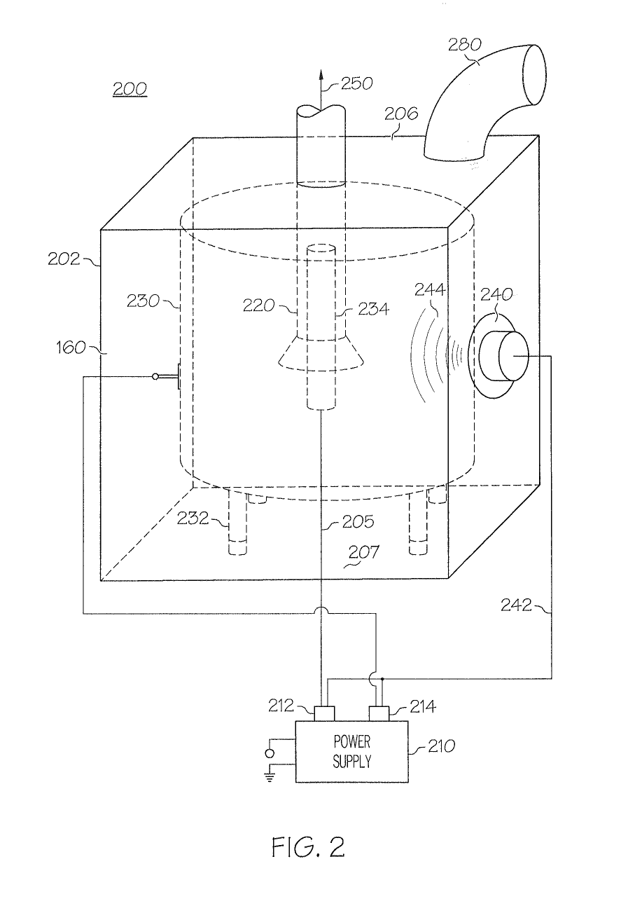

FIG. 2 is a cross sectional side view of another embodiment, referred to as hydrogen production system 200, of the present invention. Hydrogen production system 200 consists of a container apparatus 202 in the fashion of an electrolytic cell capable of storing a solution 160. The sides of container apparatus 102 are preferably non-electrically conductive. A hollow, cylindrical, electrically conductive piece 230 is held above the bottom member 207 of container apparatus 202 by supporting members 232. A second electrically conductive member 234 is held above the bottom member 207 of container apparatus 202 by supporting member 205. Electrically conductive piece 230 is connected to the positive terminal 214 of power supply 210. Thus, electrically conductive piece 230 is an anode. Likewise, electrically conductive piece 234 is connected to the negative terminal 212 of power supply 210. Thus, electrically conductive piece 234 is a cathode. A hollow, cylindrical tube 220 is connected to and passes through top member 206 of container apparatus 202. The bottom of tube 220 is flared outward and positioned so that some portion of cathode 234 is within the tube 220. Finally, a transducer 240 is connected to one side of container apparatus 202. Wires 242 connect transducer 240 to power supply 210.

Power supply 210 causes cathode 234 to be negatively charged and anode 230 to be positively charged. As a result, an electrical current is created between cathode 234 and anode 230. The cylindrical shape of anode 230 and the position of cathode 234 along the axis of anode 230 takes advantage of the electrical field produced by cathode 234 and anode 230 and helps to maximize the flow of electricity between cathode 234 and anode 230.

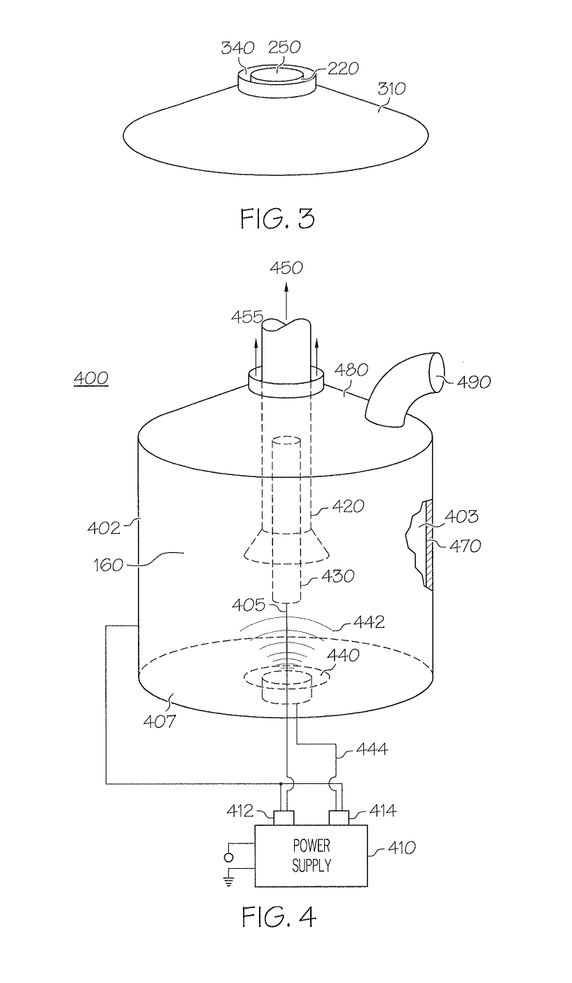

As previously described, the electrical current flowing between cathode 234 and anode 230 electrolyzes solution 160 and causes hydrogen to form around cathode 234 and oxygen to form around anode 230. Tube 250 funnels the hydrogen out of container apparatus 202 for further use (shown by arrow 250). Referring to FIG. 3, a conical piece 310 is placed on top of anode 230. Conical piece 310 funnels oxygen out of container apparatus 202 (shown by arrow 340). Referring back to FIG. 2, as solution 160 is electrolyzed and the constituent gases are removed from the system 100, additional solution can be added through an inlet 280.

Hydrogen production system 200 is the same as hydrogen production system 100 in that transducer 240 produces sound waves 244 which transmit through and cause cavitation in solution 160. This cavitation decreases the energy required to break the chemical bonds of solution 160 via electrolysis. As a result, in the presence of cavitation, a greater amount of hydrogen is produced at cathode 234 at a given voltage than in the absence of cavitation. Alternatively, in the presence of cavitation, the same amount of hydrogen is produced at cathode 234 at a lower voltage than in the absence of cavitation.

Hydrogen production system 200 is designed to be portable. In one embodiment, hydrogen production system 200 is sized approximately 8″ in length by 8″ in width by 8″ in height so that it can fit as an engine component in a vehicle. However, it is clear to one skilled in the art that hydrogen production system 200 and its components can be scaled larger or smaller without affecting the spirit and scope of the present invention. Likewise, it is clear to one skilled in the art that hydrogen production system 200 and its components can take on many different shapes without affecting the spirit and scope of the present invention. FIG. 2 shows one embodiment of the present invention where container apparatus 202 is shaped to allow maximum transmittal of acoustic energy waves 244 though solution 160. Finally, it is clear to one skilled in the art that numerous transducers 240 may be placed at various locations on container apparatus 202 and used to produce acoustic energy waves 244 in order to maximize the creation of cavitation within solution 160.

### Third Embodiment of Hydrogen Production System

FIG. 4 is a cross sectional side view of another embodiment, referred to as hydrogen production system 400, of the present invention. Hydrogen production system 400 consists of a cylindrically-shaped container apparatus 402 in the fashion of an electrolytic cell capable of storing a solution 160. Container apparatus 402 has an electrically conductive inner wall 403 and a non-electrically conductive outer wall 470. An electrically conducive piece 430 is held above the bottom member 407 of container apparatus 402 by supporting member 405. Electrically conductive inner wall 403 is connected to the positive terminal 414 of power supply 410. Thus, conductive inner wall 403 is an anode. Electrically conductive piece 430 is connected to the negative terminal 412 of power supply 410. Thus, electrically conductive piece 430 is a cathode. A hollow, cylindrical tube 420 is connected to and passes through the top member 480 of container apparatus 402. The bottom of tube 420 is flared outward and position so that some portion of cathode 430 is within tube 420. Finally, a transducer 440 is connected to bottom member 407 of container apparatus 402. Wires 444 connect transducer 440 to power supply 410.

Power supply 410 causes cathode 430 to be negatively charged and anode 403 to be positively charged. As a result, an electrical current is created between cathode 430 and anode 403. The cylindrical shape of anode 403 and the position of cathode 430 along the axis of anode 403 takes advantage of the electrical field produced by cathode 430 and anode 403 and helps to maximize the flow of electricity between cathode 430 and anode is 403.

As previously described, the electrical current flowing between cathode 430 and anode 403 electrolyzes solution 160 and causes hydrogen to form around cathode 430 and oxygen to form around anode 403. Tube 420 funnels the hydrogen out of container apparatus 402 for further use (shown by arrow 450). Conically-shaped top member 480 of container apparatus 402 funnels oxygen out of container apparatus 402 (shown by arrow 455). As solution 160 is electrolyzed and the constituent gases are removed from the system 400, additional solution can be added through an inlet 490.

Hydrogen production system 400 is the same as hydrogen production systems 100 and 200 in that transducer 440 produces acoustic energy waves 442 which transmit through and cause cavitation in solution 160. This cavitation decreases the energy required to break the chemical bonds of solution 160 via electrolysis. As a result, in the presence of cavitation, a greater amount of hydrogen is produced at cathode 430 at a given voltage than in the absence of cavitation. Alternatively, in the presence of cavitation, the same amount of hydrogen is produced at cathode 430 at a lower voltage than in the absence of cavitation.

Hydrogen production system 400 is designed to be portable. In one embodiment, hydrogen production system 400 is sized approximately 8″ in length by 8″ in width by 8″ in height so that it can fit as an engine component in a vehicle. However, it is clear to one skilled in the art that hydrogen production system 400 and its components can be scaled larger or smaller without affecting the spirit and scope of the present invention. Likewise, it is clear to one skilled in the art that hydrogen production system 400 and its components can take on many different shapes without affecting the spirit and scope of the present invention. Finally, it is clear to one skilled in the art that any number of transducers 440 may be placed on container apparatus 402 and used to produce sound waves 442 in order to maximize the creation of cavitation within solution 160.

Throughout the descriptions of hydrogen production systems 100, 200, and 400, a cylindrical tube, tube 120, 250, and 420, is used to capture hydrogen formed around the cathode and direct the hydrogen out of the systems. It will be clear to one skilled in the art that tubes 120, 250, and 450 can be replaced by any means to capture and direct the hydrogen. Such means include, but are not limited to, tubes and similarly shaped conduits, membrane filtering, diffusive evaporation, differential pressures, and channeling solution flow.

### Embodiments of Cavitation Sub-System

Throughout the descriptions of hydrogen production systems 100, 200, and 400, transducers 140, 240, and 440 are used to produce acoustic energy waves 144, 244, and 442 which cause cavitation within solution 160. It will be clear to one skilled in the art that transducers 140, 240, and 440 can be replaced by any means for generating cavitation. Such means for creating cavitation include, but are not limited to, acoustic means, mechanical means, hydrodynamic means, electromagnetic means, and ionizing radiation means.

FIGS. 1, 2 and 4 show embodiments of the present invention where the cavitation is produced by a specific acoustic means, namely, by using a transducer to pass acoustic energy waves through solution 160. However, other acoustic means can be used to produce the cavitation. It will be understood by one having skill in the art that such acoustic means includes, but is not limited to, transducers microphones, and speakers.

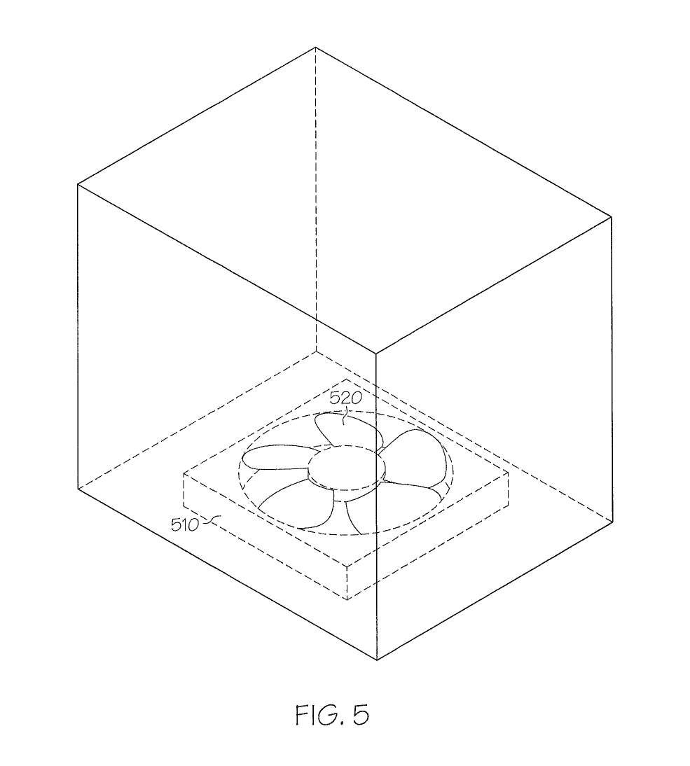

An example of a mechanical means to cause cavitation within hydrogen production systems 100, 200, and 400 includes, but is not limited to, a propeller system contained within container apparatus 102, 202, and 402, which causes cavitation as the propeller spins on its axis. FIG. 5 shows a cross sectional view of such a propeller system. As shown, propeller blades 520 spin about the axis of propeller system 510 causing cavitation to be produced in solution 160. Propeller system 510 may be powered by power source 110, 210, or 410. It will be understood by one having skill in the art that other mechanical means can be used to produce the cavitation. Such mechanical means include, but are not limited to, a propeller system, pistons, shock tubes, and light gas guns.

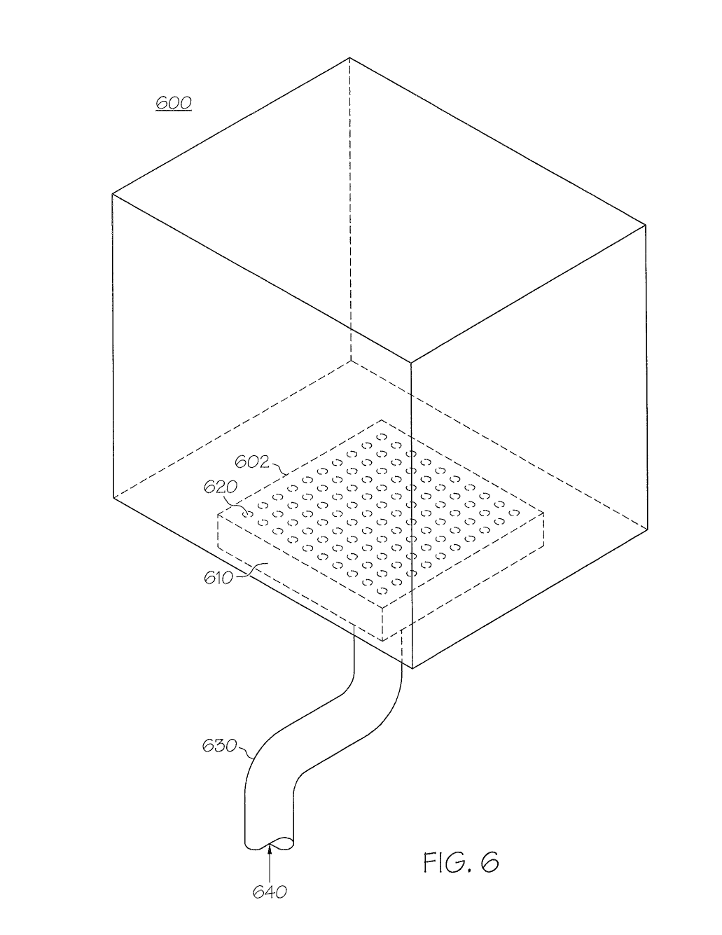

An example of a hydrodynamic means to cause cavitation within hydrogen production systems 100, 200, and 400 includes, but is not limited to, the injection of a compressed gas, for example, compressed air, into container apparatus 102, 202, and 402 to cause cavitation. FIG. 6 shows a cross sectional view of such a compressed gas injection system. As shown, compressed gas injection system 610 is affixed to container apparatus 102, 202, or 402. Compressed gas travels (indicated by arrows 640) from a compressor (not shown) through tube 630 to compressed gas injection system 610. The compressed gas flows through tubes 620 and is introduced into solution 160 as bubbles, i.e. cavitation. In one embodiment, compressed gas injection system 610 may be separated from solution 160 by a porous membrane that permits the transfer of the compressed gas through the membrane while preventing solution 160 from entering compressed air system 610. An example of such a membrane is Gore-Tex. It will be understood by those having skill in the art that other hydrodynamic means can be used to produce the cavitation. Such hydrodynamic means include, but are not limited to, a compressed gas injector system and any device capable of transferring momentum into solution 160 without transferring mass into solution 160, for example, a shock plate or paint shaker.

An example of an electromagnetic means to cause cavitation within the hydrogen production systems 100, 200, and 400 includes, but is not limited to, a laser beam directed to pass into solution 160 so as to produce a shock wave that causes cavitation within solution 160. It will be understood by those having skill in the art that other electromagnetic means can be used to produce cavitation. Such electromagnetic means include, but are not limited to, a laser beam, x-rays, gamma rays, high speed electrons, electric arc, magnetic compression, plasma generation, and electromagnetic radiation arising from any type of electron or proton reaction.

Finally, an example of an ionizing radiation means to cause cavitation within the hydrogen production systems 100, 200, and 400 includes, but is not limited to, passing high energy protons into solution 160 where cavitation is formed around the protons. Generally, ionizing radiation is any radiation that is capable of removing an electron from a chemical bond. Therefore, it will be understood by those having skill in the art that such ionizing radiation means include, but are not limited to, all electromagnetic radiation greater in energy than ultraviolet radiation and high energy particles such as photons, protons, neutrons, and charged and uncharged nuclei.

Throughout the descriptions of hydrogen production systems 100, 200, and 400, as well as the examples of the various means of causing cavitation, cavitation is said to occur within solution 160. It will be understood by those having skill in the art that causing cavitation “within” solution 160 means causing cavitation within the electrolytic zone.

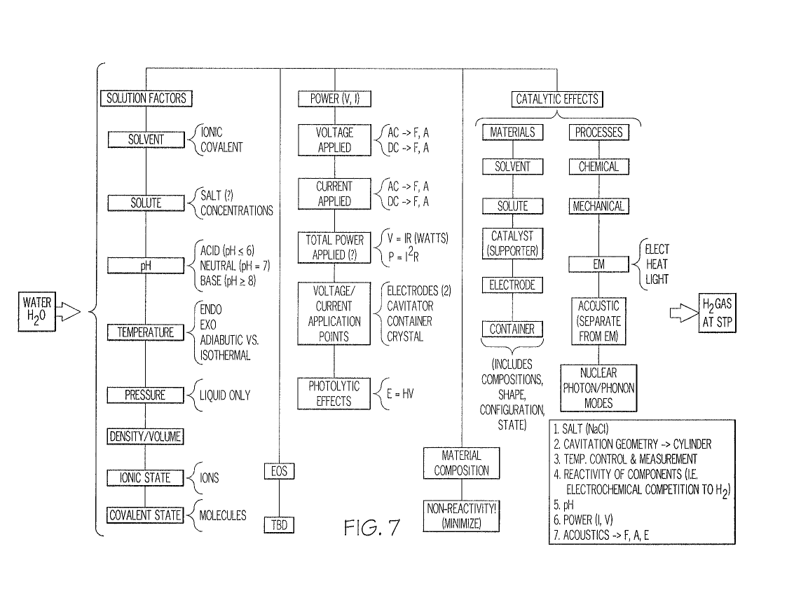

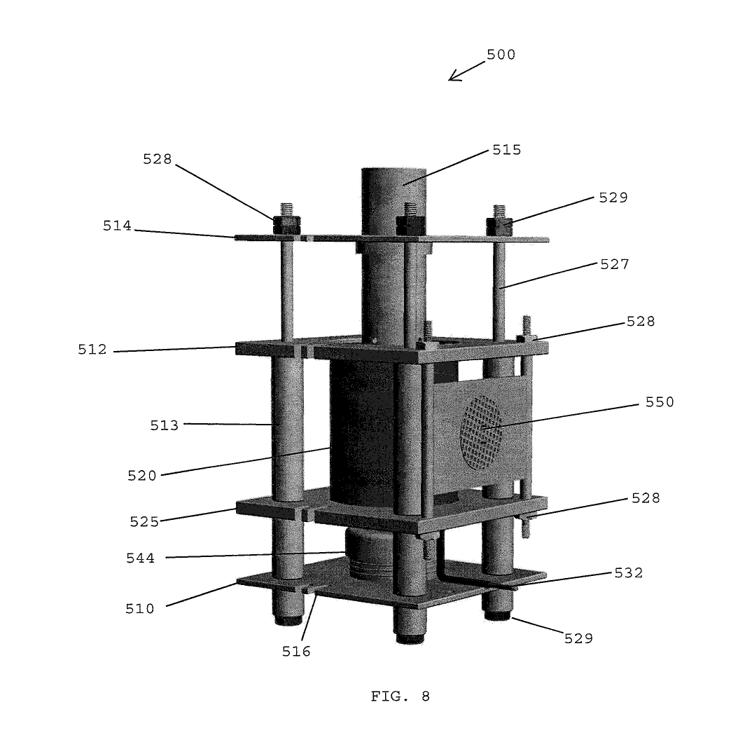

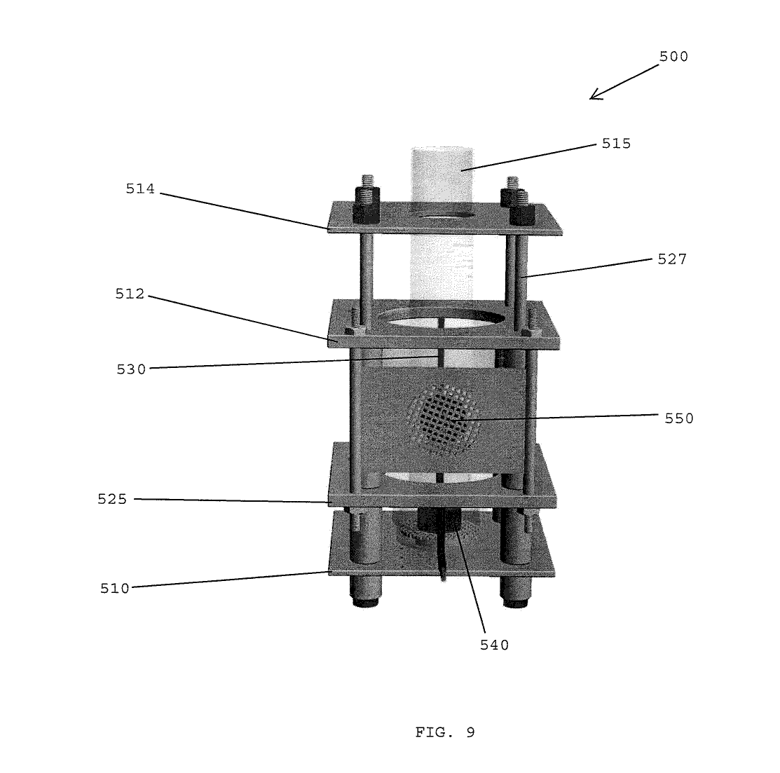

FIG. 7 is a diagram of the major factors affecting the production of hydrogen according to the present invention. Solution factors 710 are the major factors affecting solution 160. These solutions factors include a solvent and solute. As previously described, the solvent is water or another aqueous solution containing hydrogen. The solute is a chemical compound, such as acid (such as HI or HCl), base (NaOH), or salt (such as KI or NaI), and is held at a particular density per volume of solvent in order to maximize the electrical conductivity of the solution. The solution has a particular pH, and it is held at a particular temperature and pressure, whether in hydrogen production system 100, 200, or 400, to minimize the energy required to break the chemical bonds of the solvent. Finally, the solution has a particular ionic and covalent state (chemical potential).

Power factors 720 are the major factors affecting the delivery of power to cathodes 130, 234, and 430, and anodes 132, 230, and 403. It will be readily apparent to one skilled in the art that the power factors 720 include voltage applied, current applied, and total power applied. Additionally, although hydrogen production systems 100, 200, and 400 have been shown with a single cathode and single anode, it is apparent to one skilled in the art that the number of voltage/current applications points can be increased without affecting the spirit and scope of the present invention. Likewise it is apparent to one skilled in the art that the sizes and shapes of cathodes 130, 234, and 430 and anodes 132, 230, and 403 can change without affecting the spirit and scope of the present invention. Finally, it is apparent to one skilled in the art that power supplies 110, 210, and 410 can be any power producing device, such as a battery, solar panel, or fuel cell.

Material Composition factors 730 are the major factors affecting the materials of the hydrogen production systems 100, 200, and 400. The materials comprising cathodes 130, 234, and 430, and anodes 132, 230, and 403 are selected to maximize electrical conductivity. Such materials include, but are not limited to, metals such as copper, platinum, and high order non-linear crystals including, but not limited to, lithium niobate and lithium tantalate.

The catalytic factors 740 employed to enhance and catalyze the production of hydrogen are the major factors affecting the energy balance within solution 160. The non-energy input catalytic factors lowering the necessary electrolytic input energy ΔE₁ to ΔE₂ include but are not limited to: (1) process temperature (as a function of ΔE_{cav}, ΔE₂, partial molar concentrations of species), (2) container properties (composition, shape), (3) solution properties (solute/solvent composition [species, concentrations, etc.], pH, chemical potential, pressure, catalytic agents added [supported catalysts, gases such as noble gases, etc.]), (4) electrode properties (composition [elemental, isotopic, chemical], shape, microsurface [crystal planes, etc.], macrosurface [holes, edges, etc.], and (5) structure of applied electromagnetic field [energized, unenergized]).

Referring to Table 1, a set of equations is set forth showing that even in the presence of cavitation, the energy required to perform the electrolysis of solution 160 to produce hydrogen is greater than the energy that is produced when that hydrogen is recombined with oxygen. Thus, it is apparent to one skilled in the art that the teachings described herein are not directed to a perpetual energy device. Rather, because of the net energy loss that results from the electrolysis of solution 160, energy is introduced into systems 100, 200, and 400 as represented by power supplies 110, 210, and 410 to drive the electrolysis and catalytic processes.

TABLE 1

| 1 | Electrolysis (decomposition) of water requires energy input: Δ E_{dec} | |
|---|---|---|
| | 2 H₂O (l) → 2 H₂ (g) + O2 (g) | Δ E_{dec} |

| | |
|---|---|
| | Δ E_{dec}/2 = Δ E₁ ---> energy consumed per mole H₂O or H₂. |
| 2 | Formation of water requires energy output: Δ E_{form} |
| | 2 H₂ (g) + O₂ (g)→ 2 H₂O (l) Δ E_{form} |
| | Δ E_{form}/2 = Δ E₂→ energy released per mole H₂O or or H₂. |
| 3 | By the First Law of Thermodynamics, electrolysis is not fully reversible since the |
| | heat and entropy losses cannot be fully accounted for. Thus, we have the result: |
| | Δ E₁ > Δ E₂ always. |
| | As a result, the process of electrolysis/water reformation, as well as the process |
| | described herein cannot be termed a “Perpetual Motion (or Energy) Machine” of |
| | any kind. |
| 4 | The thermodynamic efficiency relation e = Δ E₂/Δ E₁ × 100% gives a guide to |
| | the relative efficiency of the electrolysis/water reformation process. An eventual |
| | efficiency of 80% or more is possible. |
| 5 | Δ E₁ (energy consumed per mole H₂O or H₂ to decompose water to H₂ gas) may |
| | be represented in the present invention by the quantity Δ E₃, which is: |
| | Δ E₃ = Δ E_{electrolysis} + Δ E_{cavitation} + Δ Eₒₜₕₑᵣ |
| | where the electrolysis term represents only the electrical energy input from the |
| | electrodes as electrolysis, the cavitation term represents only the electrical energy |
| | input from acoustical energy (or any means) to cause or sustain cavitation, and |
| | the ‘other’ term represents any energy input for heating, cooling, stirring, or |
| | measurement. Here energy is represented as the total energy (power) input as the |
| | function of current and voltage by Ohm's Law. |
| 6 | In the absence of catalytic factors 740, Δ E_{electrolysis}~Δ E₁. However, for the |
| | process described herein to be valid, Δ E_{electrolysis} must be less than Δ E₁: |
| | Δ E 1 > Δ E_{electrolysis} |
| | since the process described herein is a catalytic process which lowers the |
| | necessary energy to form hydrogen gas. Thus, the overall equation is: |
| | [Δ E₃ = Δ E_{electrolysis} + Δ E_{cavitation} + Δ Eₒₜₕₑᵣ] < Δ E₂ |
| | which requires the value Δ E₃ to approach Δ E₂. Since Δ E₁ > Δ E₂ |
| | always, the equation Δ E₁ > Δ E₃ is valid. |
| 7 | Generally, there are two kinds of catalytic factors: non-energy input catalytic |
| | factors which are based on no energy input (e.g. electrode materials, |
| | configurations, etc.); and energy input catalytic factors which are based on |
| | energy input (e.g. cavitation, heating, cooling, stirring, etc). Examples of both |
| | kinds of catalytic factors are set forth in catalytic factors 740. |

Referring back to FIG. 7, the energy input factors 750 lowering the electrolytic input energy ΔE1 to ΔE2 include, but are not limited to: (1) ΔEₒₜₕₑᵣ (energy necessary for the temperature control and measurement, mechanical, stirring, etc.), and (2) ΔE_{cav} (cavitator properties [size, shape, composition], configuration [number, density per unit area/volume, etc.], power input [f (V, I)], acoustic frequency spectrum input, electromagnetic frequency spectrum input). As described above, a cavitator can be any device capable of causing cavitation.

It has been advantageously shown that the following factors in one embodiment, hydrogen production system 400, greatly increase hydrogen production in the present invention: (1) the use of a specific acoustical spectrum to maximize cavitation in solution 160; (2) the use of sodium or potassium iodide salt in solution 160 to maximize the conductivity and chemical potential of solution 160; (3) the dissolution of an effective amount of noble gas into solution 160, such that the noble gas is completely dissolved in the solution, to electromagnetically enhance the production of cavitation thus maximizing the generation of hydrogen gas—in the present embodiment, the noble gas is preferably argon and an effective amount of noble gas to be completely dissolved in solution 160 is up to five percent (5%) at Standard Temperature and Pressure; (4) the shape and configuration of the electrodes, which for hydrogen production system 400 comprise the electrically conductive inner wall 403 and electrically conductive inner piece 430, to (i) maximize the mechanical separation of the hydrogen and oxygen gas products and (ii) maximize the electrolysis electric field by use of the cylindrical electrode configuration (which maximizes the electric field by a multiplicative ratio of the inner and outer radii); and (5) the shape of the container, for example, hydrogen production system 400 comprises an electrically conductive inner wall 403 contained within an non-electrically conductive outer wall 470 so as to electrically isolate the function of the hydrogen production system 400 from the outside world.

Likewise, although it is clear to one skilled in the art that the solution 160 may be exposed to any temperature and/or pressure and that solution 160 may be contained within either a sealed or unsealed container, it has been advantageously shown for one embodiment, hydrogen system 400, that the hydrogen production using the teachings described herein is preferably performed in a sealed, but not pressurized, container at approximately Standard Temperature and Pressure (STP).

Additionally, it is self evident that the teachings and embodiments set forth herein are focused on minimizing the amount of input energy while maximizing the output of hydrogen gas. The most important factor affecting the total input energy is electrolysis voltage. Thus, it is self evident that requiring less input voltage for the same given amount (or greater) of hydrogen gas generated will result in requiring less input energy, thus, less input power. As a result of requiring less input power, the input-output thermodynamic difference is minimized and as a result a larger fraction of input power can be generated by energy sources such as solar cells, recharged batteries, etc., thus maximizing overall efficiency and quantity of hydrogen generated.

### Fourth Embodiment of Hydrogen Production System

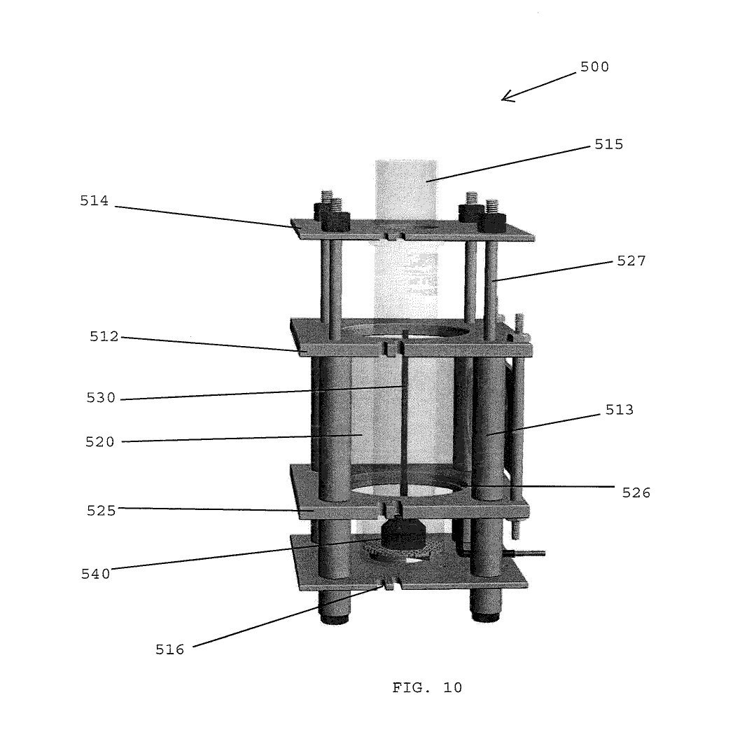

A fourth embodiment of the invention is the apparatus shown in FIGS. 8-11. Apparatus 500 is generally described as having the overall configuration and components of an electrolytic cell, with the addition of two ultrasound transducers positioned orthogonally to each other. It is to be emphasized that the apparatus is not used to conduct electrolysis per se, but is used to create a sonoelectrochemical reaction process. Therefore, the device is called “sonoelectrolytic cell” 500.

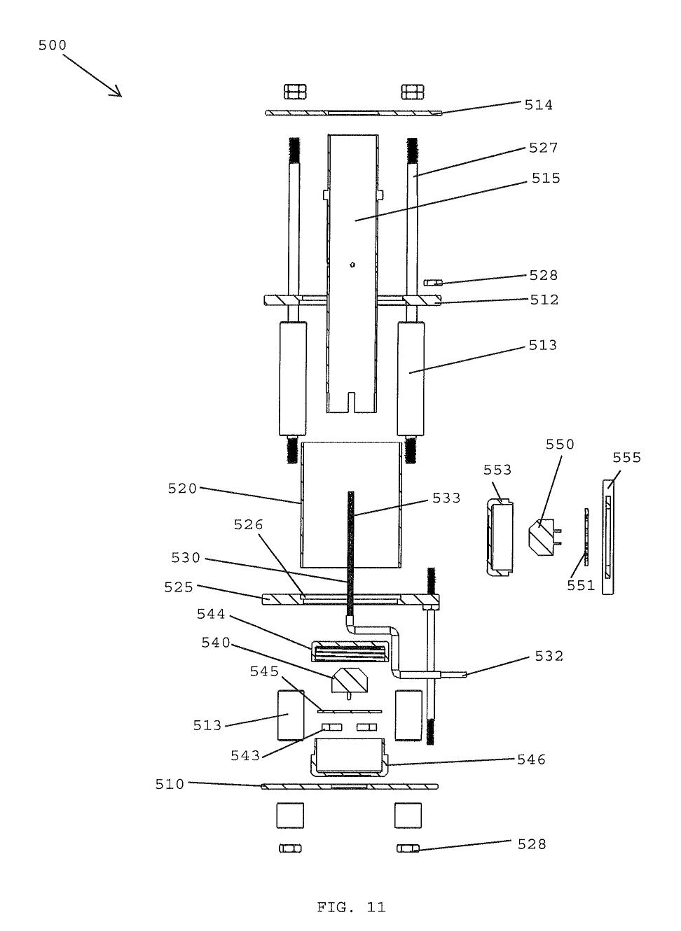

With attention directed to FIG. 8, sonoelectrolytic cell 500 is shown in angular perspective. In operation, sonoelectrolytic cell 500 would be situated inside a container for holding liquids such as aqueous electrolyte. However, for purposes of clarity the container is omitted from the drawings. The cell is comprised of a cylindrical anode 520 mounted on anode support plate 525; a cylindrical cathode 530 (best seen in FIGS. 9-10) located inside the anode 520; an ultrasonic bottom transducer 540 mounted under the anode support plate 525 and oriented to transmit along the axis of the cathode 530; and a transverse transducer 550 mounted at a 90 degree angle to the bottom transducer 540. Each transducer has a pair of terminals 541a and 541b for positive and negative leads, respectively. Not shown in these figures are the electronics for driving the transducers, power supply for the electrodes, or a gas removing means for removing any evolving Hydrogen.

The supporting skeleton comprises four support plates 510, 512, 514 and 525. Base support plate 510 has various holes therethrough for receiving and/or supporting various structural and functional components such as the tie rods 527 and anode 520. Lower anode support plate 525 has a stepped cutout 526 that serves to support the lower end of anode 520. Upper anode support plate 512 has a similar cutout that allows the two anode support plates 512, 525 to “sandwich” the anode when the opposing nuts 528 are tightened thereby clamping the anode in place between upper and lower anode support plates 512, 525, respectively. Spacer supports 513 are non-conductive tubes that thread over support rods 527 and provide additional structural rigidity to the device. Gas collection tube support plate 514 is the fourth support plate and is located above the upper anode support plate. It has a cutout for the gas collection tube 515, which extends from the top of bottom transducer housing 544 to a gas collection tube adapter (not shown). Gas collection tube 515 surrounds the inner electrode (cathode 530) and is located between the inner diameter of the anode and the cathode. In one embodiment the tube may be 1″ diameter, in another embodiment it is 2″. The functions of the gas collection tube 515 are to collect hydrogen gas evolved in the electrolyte volume around the cathode 530, to direct the gas upwards either entrained in fluid flow or as bubbles, and it may also have a focusing effect on the electromagnetic fields generated by the electrodes. The support plates may also have orienting criteria such as a notch 516. The plates may be oriented horizontally as shown, or vertically. The plates in this case are made from NYLON® (DuPont, Wilmington, Del.) approximately ¼ inch in thickness, although other materials are equally suitable so long as they can maintain some structural rigidity. The four plates are held in horizontal orientation by four tie rods 527 which are also NYLON, and are threaded at their ends to accept nuts 528. There are also power leads (anode lead (not shown) and a cathode lead 532). Cathode power is defined as being negative, and the anode is positive. Power to the bottom and transverse transducers was applied through twin leads (not shown in this embodiment).

FIGS. 9 and 10 show the anode 520 and gas collection tube 515 as partially transparent so that the inner cathode may be seen. The anode 520 and cathode 530 may be made from any suitable electrically conductive metals commonly used in electrolysis. The cylindrical anode 520 was made from solid copper pipe having dimensions 5.4 cm OD by 5.1 cm ID, and a height of 6 cm; Grainger, Copper streamline tube, Fulton, MS Type M NSE/ANSI, 61-G. The cathode 530 is two pieces, a central 14-gauge copper wire (2 mm OD), and a cylindrical solid copper mesh 533 slipped over it, approximately 2 mm OD, 2 mm ID, height 6 cm; 99.9% pure copper mesh; 0.010 thick; Stock no. 6095, K&S Engineering, Chicago, Ill. The cathode shape is that of a concentric cylinder having a fixed diametric ratio of approximately 1:25 relative to and inside the anode, as measured according to the inside diameter of the outer anode compared to the outside diameter of the inner cathode. The cathode was located concentrically along the axis of the anodic volume. The copper wire was sourced from Home Depot, and is 99.9% pure copper wire—14 gauge; 600 volt; VW-1 rated; Issue No. YM-680,590.

FIG. 11 shows how the transverse transducer 550 was supported. Transverse transducer housing cap 553 covers and is in direct contact with transverse transducer 550. Mesh 551 is provided for terminals 541a,b to penetrate. Mesh 551 is glued to transverse transducer support plate 555. Cap 553 is similarly affixed to plate 555 thereby resulting in transverse transducer 550 being contained and supported in a vertical manner and aiming directly at the side of anode 520. Bottom transducer 540 is contained within the bottom transducer housing base 546 and the bottom transducer housing cap 544. They are both threaded to receive each other. Split ring 543 and mesh 545 support the transducer 540. The top of bottom transducer housing cap 544 is affixed to the bottom of lower anode support plate 525 so that when the bottom transducer housing base 546 is screwed in, it retains all the elements snugly.

A DC power supply (30 volts/3 amps) (3 channel programmable BK Precision Model 903) was used to power the sonoelectrolytic process. A frequency generator drives the transducers.

The electrolyte used to generate the attached hydrogen production data was an aqueous solution of citric acid, NaCl and NaI. 121.731 g NaCl, ACS grade reagent, Aqua Solutions, Deer Park, Tex., Cat. No. S2675-2KG was dissolved in 2 liters of water purified by reverse osmosis. Next, 20.560 g Citric Acid-ACS grade (ACROS, Cat No. 42356-0020) was dissolved in the same solution. Then 3.54 mg Reagent Grade NaI from MP Biomedicals, Solon, Ohio, Cat No. 193979 was dissolved in the electrolyte solution. Argon was bubbled through the solution prior to use sufficient to displace other dissolved gases.

Hydrogen was produced according to the following electrolysis protocol. All potentials mentioned are direct current (DC) unless otherwise noted. First, the electrolyte solution was “charged” or brought to potential. Priming or charging is the process of applying an electric potential to the solution which retains a portion of the charge throughout and after the reaction has concluded. It is currently understood that the solution possesses a complex dielectric function c and thus functions similar to a resistive capacitive network. The charging step is required of all methods to induce hydrogen production. Bringing the solution to potential alleviates the delay normally associated with initializing electrolysis. On a molecular level, this causes the ion channels to start “flowing,” and promotes electron exchange. The initial runs to bring the solution to potential are relatively straight-forward. The electrolyte in the apparatus was brought to a set current of 1.5 Amps with the voltage set at 20V. When the current approached the set value of 1.5 Amps, the voltage was observed to be between 6-8 volts. The solution was held at these values for approx. 5 minutes and then the power applied was turned off. This particular procedure was carried out at least once, sometimes twice. At this point, the solution was considered to be charged (at potential).

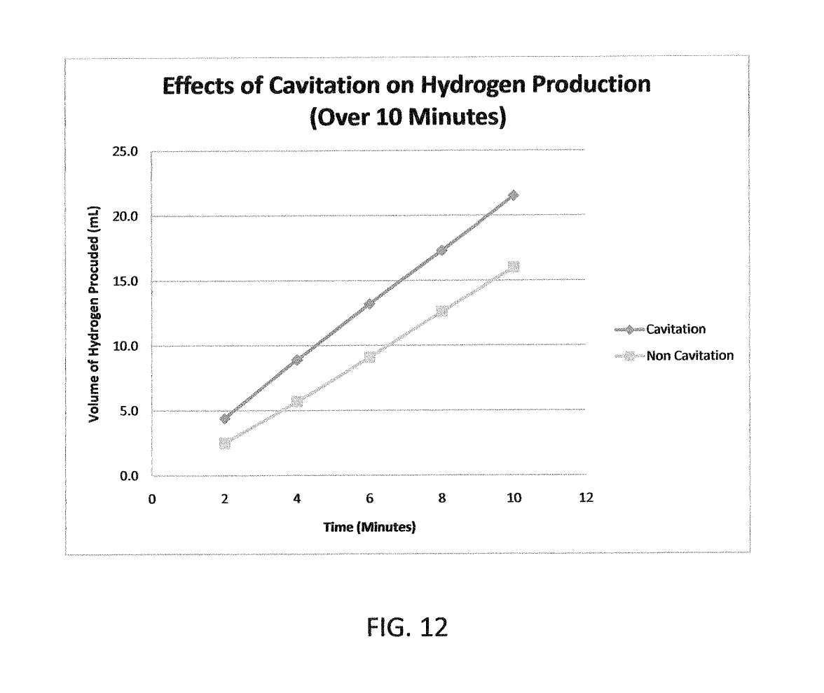

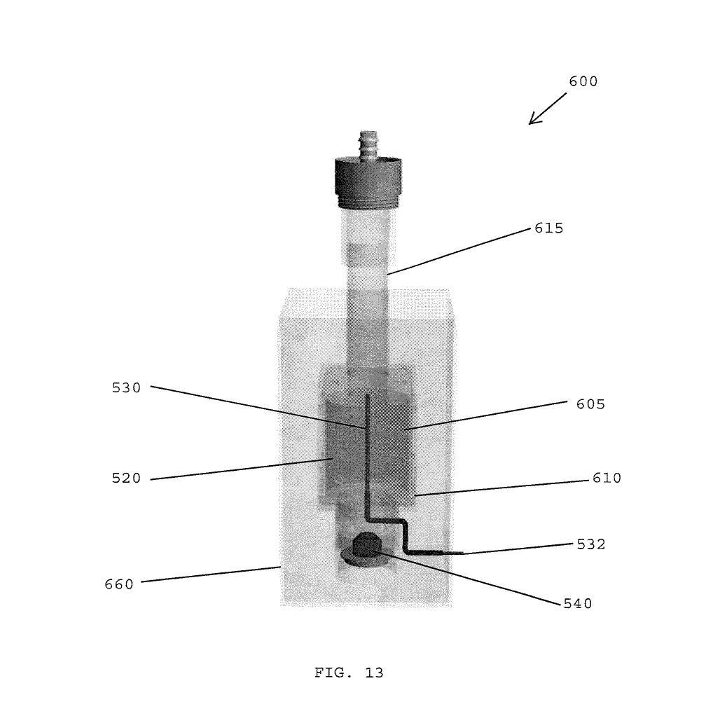

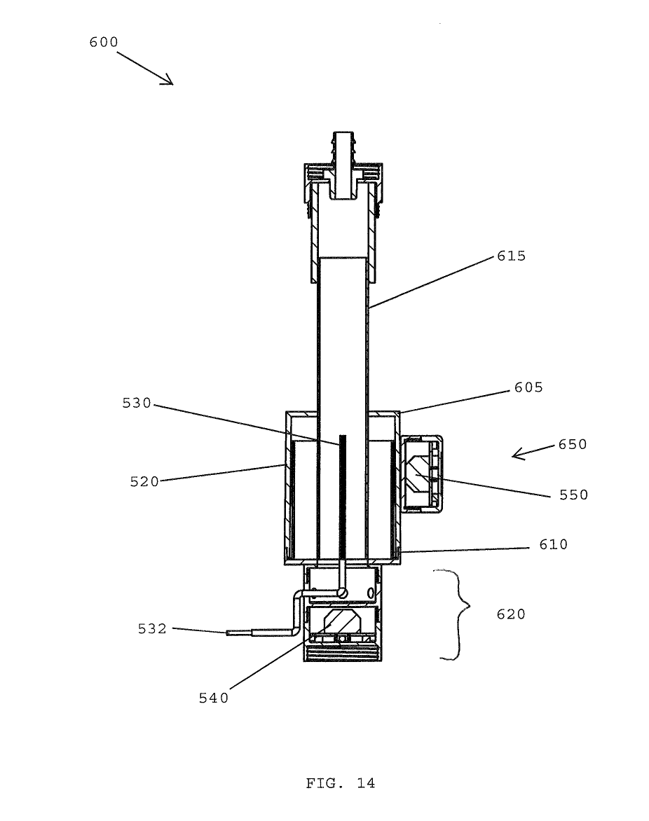

The positive power lead was attached to the anode; the negative lead was attached to the cathode. The transducers were attached to the function/frequency generator (if using cavitation). The power supply was set to float with a voltage ceiling of 20V, while the amperage was set at a fixed value (which ranges from 250 mA to 2.0 A). Any suitable function generator can be used to drive the transducers, but preferred generators include a PROTEK B8012, or a QUAKKO 5000 digital signal generator. The transducers were set at 3.3 V, and drew about 10-20 mA. Frequencies were set at 38.248 kHz for the transverse/horizontal transducer, and 76 kHz for the bottom transducer. The transverse transducer 550 was located 2.6 cm from the center of the cell; the bottom transducer 540 was located 5.2 cm from the center measured from the face of the transducer. Both transducers were oriented towards the center of the cell. The central area of the cell is thus considered the “reaction zone” for purposes of this apparatus 500. The transducer used in the present invention was a Piezo Air Transducer, Part No. SMUTF40TR18A, Steminc (Steiner & Martins, Inc.), Miami, Fla. Hydrogen was produced in the quantities indicated in the attached graph (FIG. 12).

### Fifth Embodiment of Hydrogen Production System

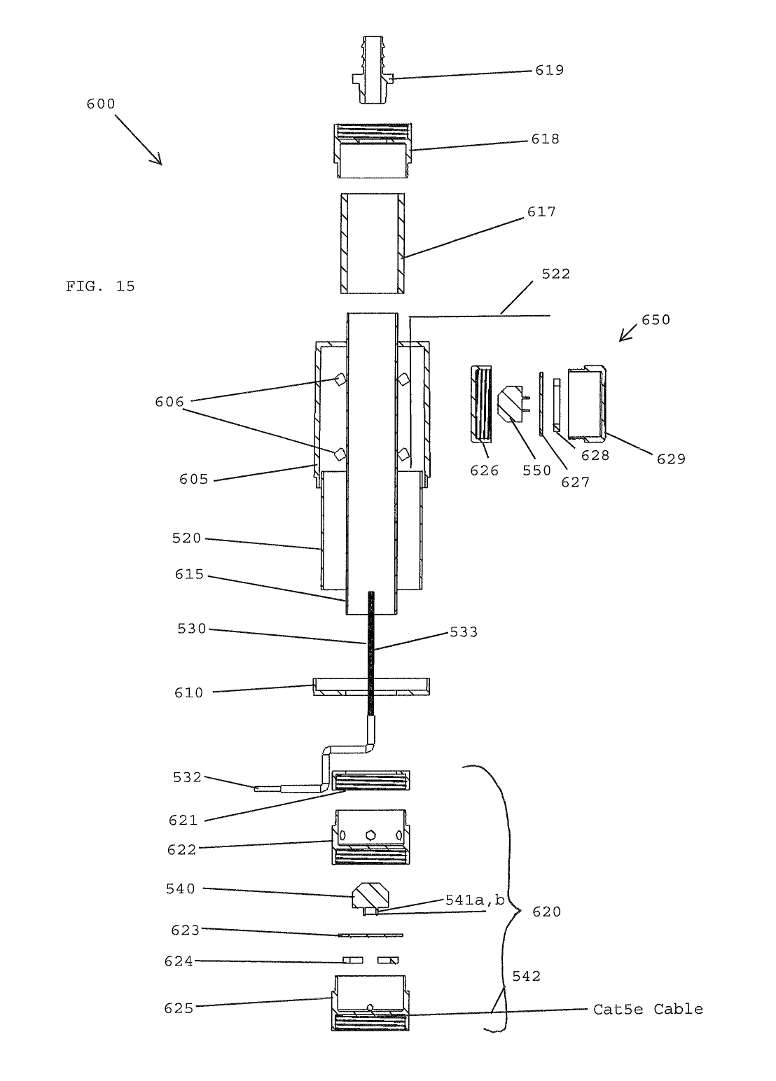

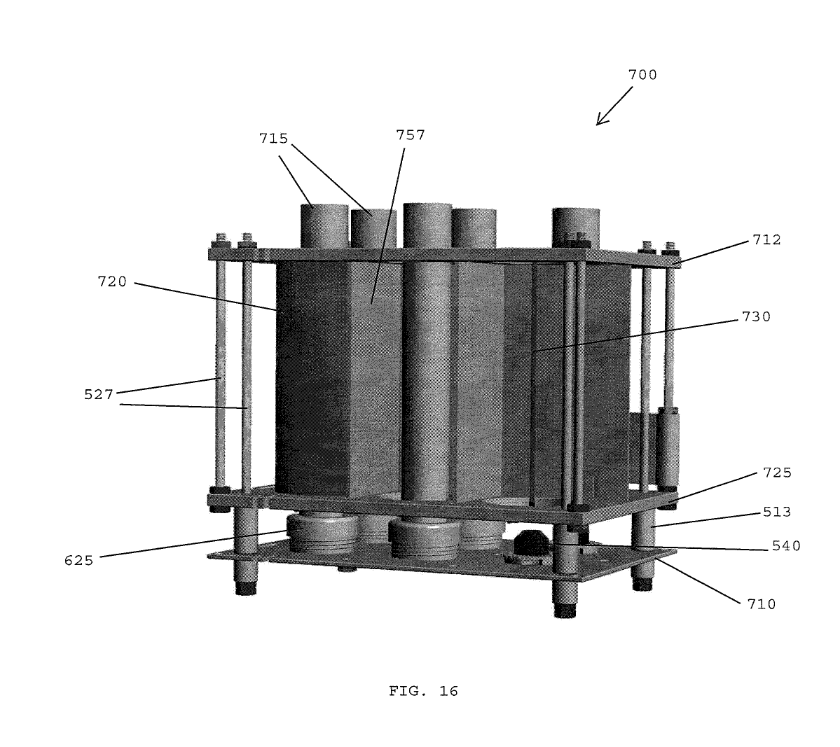

FIGS. 13-15 are directed to a fifth embodiment of the invention, 600. It is also a single-cell sonoelectrolytic cell (also described herein as a “hydrogen extractor,”) but varies from the fourth embodiment as follows. It was developed with the goal of simplifying the construction and assembly of the extractors. The superstructure, or external skeleton, of the apparatus is a two-part transparent acrylic box 605 commonly available at arts and crafts stores. The box is 7.62 cm×6.03 cm×6.03 cm and has an acrylic lid 610 with complementary edges that facilitate the lid fitting snugly into the box's open end. The centers of both lid 610 and the bottom of the box 605 were drilled out to 1 inch diameter so that they can accommodate a 2.54 cm/1″ OD gas collection tube 615 that runs the length of the box (longitudinally). Tube 615 is a relatively thin transparent acrylic tube (commonly used in aquariums and referred to as a gravel tube). In general, tube 615 runs through the middle of the box between the cathode 530 and the anode 520 and terminates at the lower transducer unit. In operation, apparatus 600 is flipped so that lid 610 becomes the bottom of device 600. Gas collection tube 615 terminates at an adapter 617, a filter housing 618 and a MPT adapter 619. These last three elements are to interface with the gas collection apparatus 750, described in more detail infra

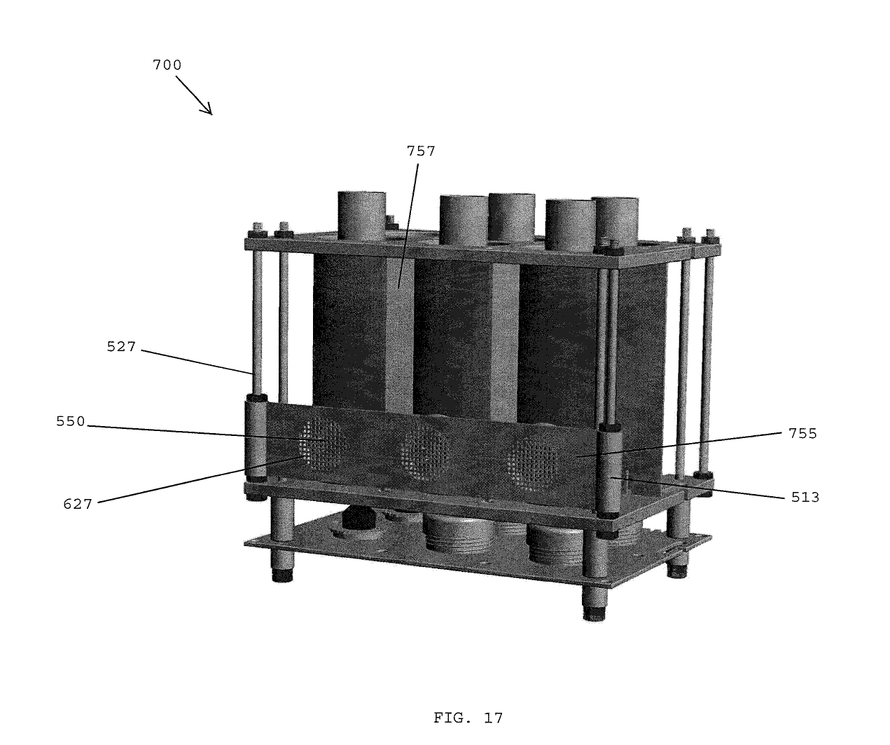

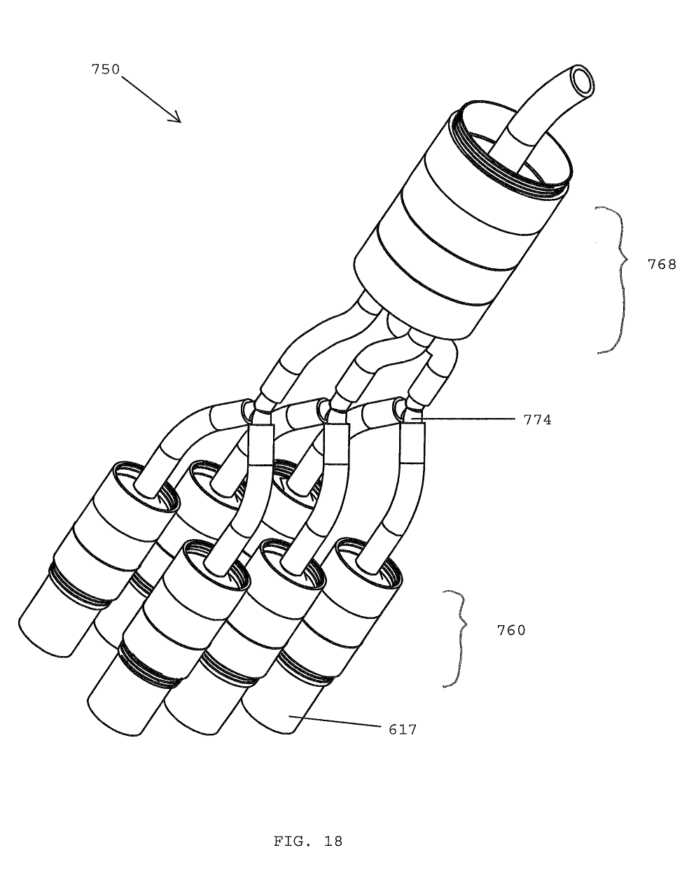

Attached to the middle of the lid 610 are two components combined into one unit, the cathode-bottom transducer unit 620 (see FIGS. 14-15). The bottom transducer 540 is contained within the same parts as in the Fourth Embodiment except that the bottom transducer housing cap 544 is replaced by cathode housing 622. In this embodiment, the transducer 540 is retained by bottom transducer housing 625 and cathode housing 622. Each has a threaded extension and a threaded receiving portion so that the housings may be threadably stacked. Each has a closed bottom and an open top. Bottom transducer housing 625 serves two functions: to house and keep the bottom transducer 540 isolated from direct contact with the electrolyte (which causes surface pitting), and to provide a superstructure for mounting the transducer to.

The cathode 530 is retained by the cathode housing 622 and cathode housing lid 621 in combination. Transducer housing 622 screws into the bottom of cathode housing 622. Cathode housing 622 retains the base of center electrode (cathode) 530 and allows for attachment to the box lid 610 by attachment of the cathode housing's lid 621 which was previously permanently attached to lid 610. The transducer itself is located in the second or lower of the two threaded boxes, as shown in FIGS. 13-15. The cathode housing 622 is 2.23 cm in diameter and 2.54 cm in height. A 1″ OD hole was drilled through the cathode housing lid 621 to accommodate the gas collection tube 615, which penetrates the cathode housing lid 621 and stops at the floor of the housing 622. The cathode housing 622 was then affixed to the lid 621 with silicone. After the cathode housing lid 621 was attached to the box lid 610, the cathode lead 532 was inserted through the center hole of the cathode housing lid 621 and up through the box lid 610. Slots 616 were cut into the bottom of the gas collection tube to accommodate the cathode lead 532. The gas collection tube 615 has some holes, approximately 2 holes per inch of length, ⅛ inch diameter, to allow for electrolyte communication between anode and cathode. All leads were sealed with silicone to ensure water-tightness.

Apparatus 600 operates with two identical acoustic transducer units, the cathode-bottom transducer unit 620 as previously described, and the transverse transducer unit 650, are attached to box 605 at the positions indicated in FIGS. 13-15. Transverse transducer unit 650 comprises a transverse transducer 550, a transverse transducer housing 629 with transverse transducer lid 626 attached to the side of box 605 at 3 cm above the base. Mesh 627 and split ring 628 are used in the same manner as in the bottom transducer. Electrical connections to the transverse transducer are omitted for purposes of clarity, but are presumed to be similar to the wiring scheme shown for the bottom transducer, i.e., to CAT5e cable. Installation and removal of the transducers is simply a matter of screwing in or unscrewing the transducer housing into the lid. For circulation purposes, through the sides of box 605 ¼ inch holes 606 were drilled in the corners to allow the circulation of the electrolyte fluid in the cell. Their exact position is not critical.

With respect to FIG. 15, the cathode-bottom transducer unit 620 is shown in more detail. Inside each round 2.23 cm dia. bottom transducer housing 625, the two transducer leads 541a,b were inserted through a round piece of 100% NYLON mesh 623 about 1/16 inch thick, and then the leads 541a,b were soldered to CAT5e cables, shown in FIG. 15 connected via bottom transducer lead 542. This assembly sits on a TYGON® split ring 624 (split to allow wires to pass) which in turn is in contact with the floor of bottom transducer housing 625. The TYGON split ring 624 is simply a section of tubing cut to elevate the mesh thereby providing a better fit and keeps the transducer from shifting within the housing. The bottom transducer lead 542 exits the bottom transducer housing 625 through a hole (not shown) and is sealed in by 100% silicone sealant. Not shown are the solid-and-striped twisted-pair CAT5e Ethernet 100 mHz cables, which are connected to the terminals through bottom transducer lead 542 and allow them to be bundled. The bundles are then inserted into CAT5e patch terminals. The terminal blocks are then soldered into B&C connectors.

Apparatus 600 sits in a watertight tank 660 (FIG. 13) that holds the electrolyte solution. Several holes were drilled into box 605 and lid 610 to allow fluid to circulate from the tank 660 to the cell.

The apparatus 600 uses the same two electrodes which are cylindrical in shape, previously described in the fourth embodiment. As previously described, the two electrodes are designed following a specific ratio of 1:25 (cathode:anode) diameters, respectively. This ratio has been experimentally determined to be optimal for a 5.4 cm OD anode, resulting in best efficiency and best hydrogen production to date. The 6 cm high inner electrode (cathode) is constructed of a solid copper mesh, 0.010″ thickness (K& S Engineering, Chicago, Ill.), that has been pulled to elongate the diamond-shaped holes and then rolled to an outside diameter of 2 mm. The cathode sits inside the 6 cm high outer electrode (anode) which is constructed of a 5.4 cm OD/5.1 cm ID solid copper pipe to result in 2 concentric cylinders, as previously described in the fourth embodiment. The anode 520 was inserted into box 605, lid 610 is then attached, and then box 605 is inverted. The anode lead 522 is fed through one of the holes in the original bottom 606 of the box 605 (now the top) and pressed against the anode, forming a simple but solid electrical connection.

The cathode lead 532 is a 14 gauge solid copper wire that is inserted vertically through the bottom of the apparatus through the cathode housing 622. The copper mesh 533 slips over the lead 532. The anode lead 522 is likewise a 14 gauge solid copper wire. In the fourth embodiment, the lead is formed into a loop and encircles the circumference of the anode. However, in the fifth embodiment the lead is formed into a semi-circle and only rests on an end, in this case the top, of the anode.

### Sixth Embodiment of Hydrogen Production System: Multi-Celled Extractors

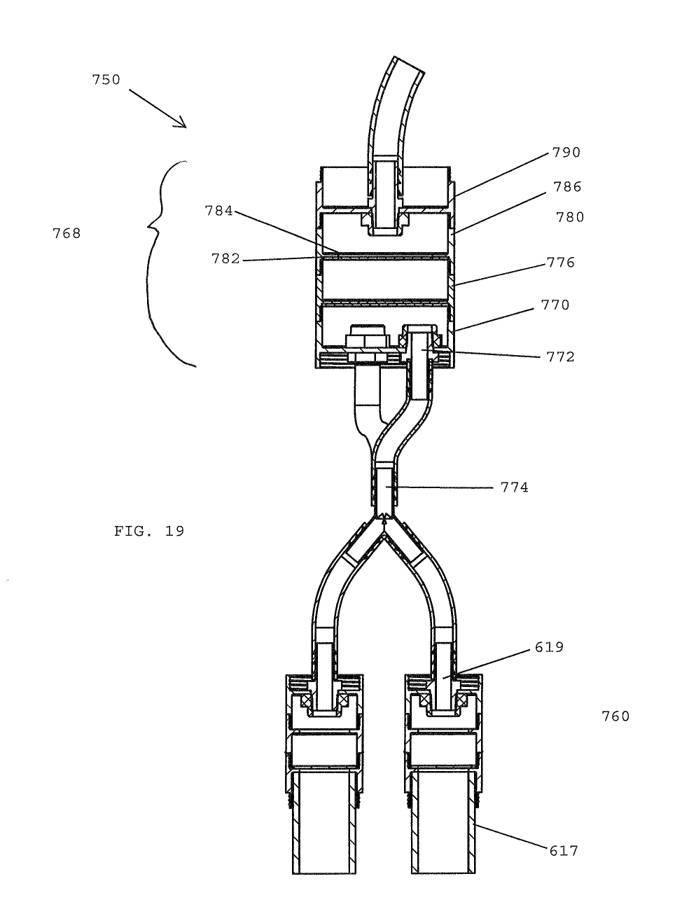

Further embodiments of the invention utilize multiple cells of the previously described embodiments arranged to generate hydrogen together in a common holding tank of recirculating electrolyte, thereby multiplying the effective gas production. A “cell” is considered to include a cathode/anode combination, its supporting structure, the acoustic transducers, and all attendant electrical, gas and liquid connections. Scale-up of the fourth embodiment is shown in FIG. 16 with six cells comprising the embodiment. Other arrangements include four-, 8- and 12-cell systems, although there is no limit regarding the actual number of distinct cells that may be employed in a multi-cell system.

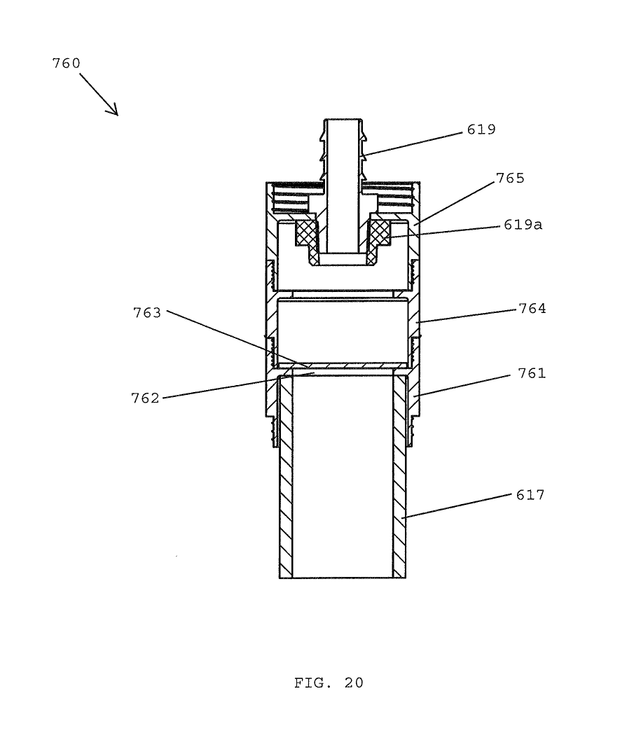

As seen in FIG. 16, a six-cell hydrogen extractor 700 was designed to include the individual cells and component parts of the fourth embodiment and consists of six separate and independently functioning cells, all dimensionally stabilized and locked by the support plates. FIG. 16 is a front view of a partially assembled multi-cell extractor that includes a fully-assembled cell on the left, a unit missing its anode in the middle, and a right-most unit missing both anode and gas collection tube 715 on the right. One significant difference between the single cell and this multi-cell configuration is that the anode 720 in this design is twice as long as that in the single-cell design, which allows space for the addition of another transverse transducer. However, the position of the transverse transducer in this embodiment is the same as in the single-cell design. It is anticipated that the addition of another transducer would result in an increase in the amount of hydrogen produced. The transverse transducers 550 are present in FIG. 17, in which the three transverse transducers 550 are located in front of the NYLON mesh 627 through which the transducer terminals project slightly. Transverse transducer support plate 755 is also longer in this multi-cell unit than in the fourth embodiment. Support plate 755 is attached to the spacers 513 which are threaded over the tie rods 527. Cell separators 757 are sheets of ⅛ thick LEXAN or similar material, and serve to physically and electrically isolate the cells. Another difference from the single-cell is that only three support plates are used in this design to secure the electrodes, transducers and associated electrical harnesses (not shown).

Another distinction, but one not thought to make a difference, is the material from which the plates were made. This embodiment uses LEXAN instead of NYLON for the plate infrastructure—the three plates have been measured to allow the placement of six cathode/anode assemblies as well as their respective pairs of transducers. The spacing between the plates remains the same as that of the single-cell extractors and is essentially a design choice. In the case of the six-cell arrangement, each plate is 21 cm×15 cm×0.25 cm. In addition, there is one vertical plate holding the transverse transducers, the previously described transverse transducer support plate 755. This plate is 11 cm wide with a height of 4.1 cm, drilled out to accommodate the transducers as well as their respective caps, and sitting upon 8 cm nylon rods. In FIG. 17 plate 755 is adapted to support 3 transducers. Another such plate with three more transducer units could be easily accommodated in this design.

The holding tank (not shown) that the six-cell extractor sits in was made from LEXAN or similar electrically insulating material. Other materials may also be used such as glass or polycarbonate so long as they are capable of holding weakly acidic aqueous solutions and are electrically insulating thereby reducing the risk of electrical shock. A top enclosure, not shown for purposes of clarity, seals the electrolyte from the atmosphere and allows for the continuous saturation of the solution with Argon. The tank was fitted with an external electrolyte recirculating pump. Standard pipe fitting connections similar to those used to build the gas capture apparatus were used for recirculation of the electrolyte. A Flojet Compact Automatic Water System Pump, 12v, Part No. LF122202 was used for recirculation, with an approximate flow rate of 3.8 liters/minute. A gas collection interface was also included in the multi-cell unit, as described in relation to the sixth embodiment.

### Gas Separation and Collection Apparatus

Embodiments of the inventions disclosed herein also are directed to means and methods for recovering and/or separating the evolved hydrogen gas from the liquid electrolyte within the cells. Generating the chemical reactions that liberate H₂ gas is a separate consideration from separating the gas from the liquid. One approach is to simply apply a slight vacuum to the saturated solution and by doing so extract the evolving hydrogen.

A first embodiment of a gas-liquid separation and capturing device may include a gas collection tube 715, previously discussed in the preceding embodiments as gas collection tube 615, that is axially positioned between the anode and cathode as shown in the preceding figures. The tube functions to both collect gas in the form of bubbles, and to help influence the electric field in the gap between the anode and cathode. The diameter of the tube may vary, but in the present embodiment preferred versions of the tube may be approximately 5.08 to 2.54 cm in diameter. The tube may also be adapted to participate in the recirculation of the electrolyte and as such it would function as a conduit.

As best seen in FIGS. 18-19, a gas collection apparatus 750 for use in the six-cell embodiment is shown. Each individual gas collection tube 615 (not shown) may also include a gas collection tube adapter 617, a membrane or filter unit 760 within its length or positioned immediately thereafter and positioned laterally so as to force the full volume of gas in the tube to traverse the membrane. The filter/membrane unit 760 functions to at least partially separate the aqueous electrolyte from the gaseous products evolving within the volume of the tube in the electrode area and so comprises a first stage filter. Any filter/membrane capable of performing the separation fall within the scope of the claims, but particularly preferred are hydrophobic gas-permeable membranes capable of resisting rupture under vacuum. Also included is tubing connecting the individual filter/membrane units to the manifold 768 which functions as a secondary filtration unit.

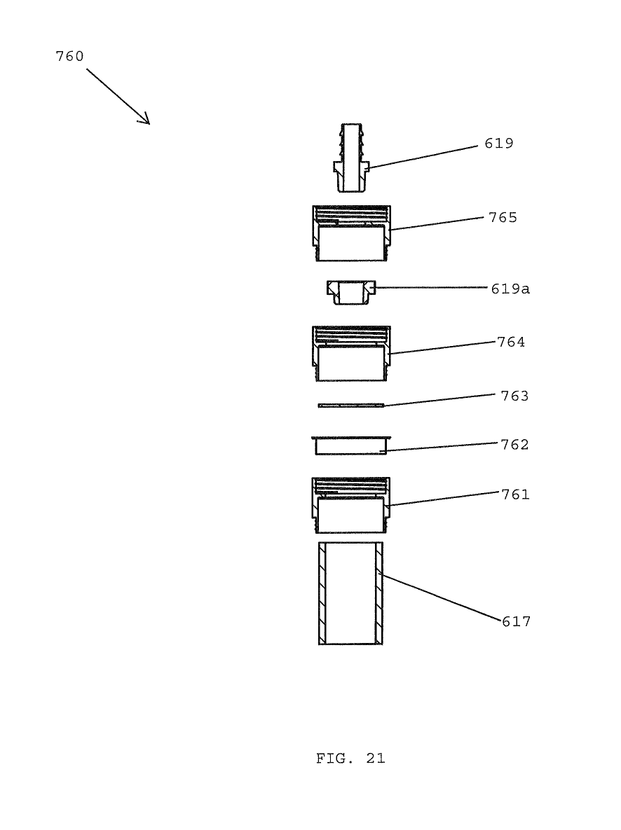

As shown in more detail in FIGS. 20-21, a membrane/filter unit 760 comprising a stacked array of the same round acrylic boxes used as transducer housings were engineered to function as a in-line filter holder to separate the gas being produced from the electrolyte. The current membranes are from the PALL Corporation, Cat. No. PTF045LHOP-SAMP. They feature a hydrophobic layer that faces the electrolyte and prevents liquids from passing but allows gases to pass. Construction of the membrane/filter unit 760 started with gas collection tube adapter 617, which is a section of TYGON tubing measuring approximately 5 cm in length and 2.54 cm ID. It was sealed with pure silicone adhesive into lower filter housing 761 that is 2.23 cm in diameter and 2.54 cm long. Within the upper portion of lower filter housing 761 there sits a support 762 that comprises piece of TYGON tubing that is 1.5 cm long and 2.225 cm in diameter. Also part of the support and residing on top of the TYGON tubing is a 2.225 cm diameter circular piece of 100% NYLON mesh, proceeded by a rubber O-ring that is approximately 2.225 cm in diameter (not shown). Filter/membrane 763 sits on top of this supporting assembly.

Filter/membrane 763 was secured into contact with upper filter housing 764 by screwing upper filter housing 764 into lower filter housing 761. Upper filter housing 764 was then screwed into membrane/filter top 765. At the end of upper filter housing 764, a ⅜ in. poly vinylidene fluoride (PVDF) male pipe thread (MPT) adapter (½ in. pipe to ½ inch barb) was attached via threaded nut 619a and also glued into place. These attached to a ½ in ID TYGON tube. Each peripheral edge of the containers was then siliconed to prevent any air leakage. Other filter holders designs will be apparent to one having ordinary skill in the art.

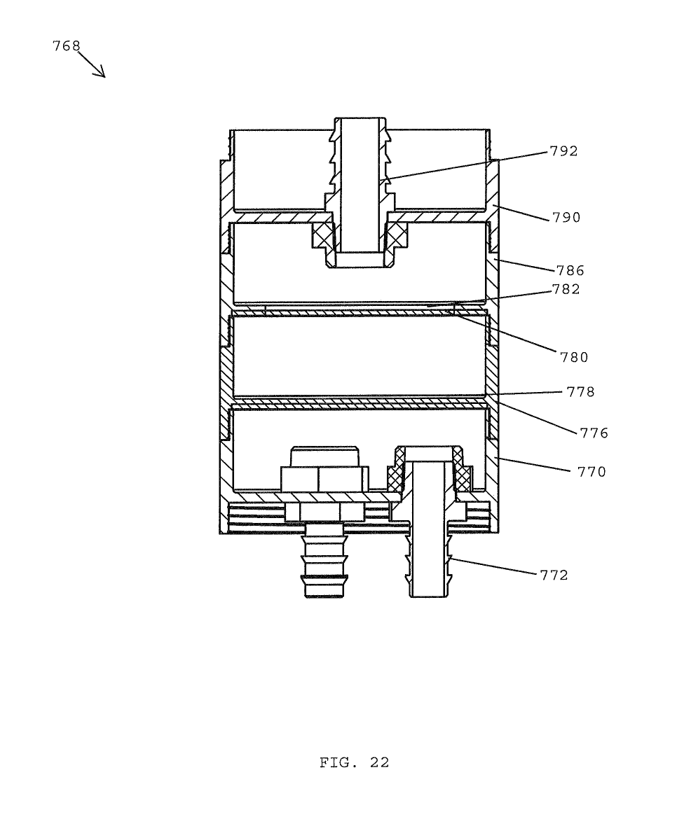

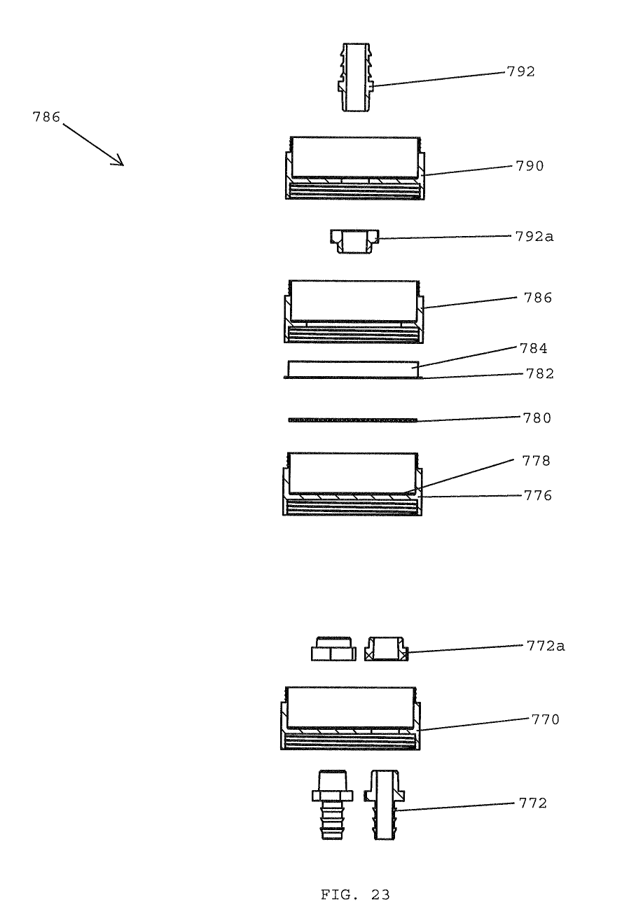

A similar design was used in the next stage of the gas collection and separation system, the manifold 768 that collects the outputs from all the membrane/filter units. The filter material and filter holder design was the same as that just described, but the dimensions are larger. The manifold 768 is shown in FIGS. 22-23. As shown, all the gas collection tube adapters 617 from the extractors feed into the bottom portion of the manifold base portion 770, which is fitted with a plurality of male pipe thread to male pipe adapters 772 that reduce from ½ inch male pipe thread to ⅜ inch ID barb. The manifold base portion 770 is the bottom of a two-part round plastic threaded container with threaded lid that is approximately 7 cm in diameter and 3.2 cm long. It has been adapted to fit three 0.95 cm poly vinylidene fluoride (PVDF) male pipe adapters 772 attached and glued into place. Off each of these is a barbed Y-adapter 774 (FIGS. 18-19) that allows two cells' tubing to connect to one of the three male pipe adapters. A second round plastic container of the same dimensions is screwed into the modified manifold base 770, which is the lower filter housing 776. Lower filter housing 776 has been drilled out to roughly 5 cm leaving a “lip” 778 to support the edge of the membrane 780. Lip 778 provides a platform for the 5 cm circular 100% NYLON mesh 782 and the 5 cm O-ring 784. Membrane 780 is placed over O-ring 784. Upper filter housing 786 is screwed into lower filter housing 776 to secure membrane 780. Manifold top 790 having the same dimensions is attached by screwing it into the upper filter housing 786. At the end of manifold top 790 is a 0.95 cm PVDF male pipe adapter 792 having dimensions of ______x______ attached and glued into place.

Another embodiment of the gas recovery and/or separation device comprises a hollow fiber membrane filter (not shown). The filter is of the two-phase, counter-current design whereby liquid electrolyte is admitted at a first proximal end, and a sweep gas enters a series of parallel, interconnected gas-permeable hollow fiber membranes at a second, distal end. The dissolved gases in the liquid permeate the fibers and are taken up by the sweep gas. An example of such a filter is the Liqui-Cel model, available from Membrana-Charlotte, Charlotte, S.C. Typically it may be located in the electrolyte recirculation system. Sweep gas in not necessary in all circumstances, especially if the outlet is under vacuum. Another embodiment of the gas-liquid separation device comprises an expansion tank. An expansion tank may be part of the electrolyte recirculation system, and will function to “siphon off” the gas from the top of the tank at the same time that liquid is recirculated through it. Still another embodiment may include a temperature-related gas-liquid separator. For example, it is known that the partial pressure of a dissolved gas is related to the liquid temperature, with higher temperature of the liquid generally correlating to a lower amount of dissolved gas. Therefore, by evolving hydrogen at a comparatively low temperature and removing gas at a higher temperature, one may be able to cause some or all of the hydrogen to be released from the electrolyte in the expansion tank. One or more of these gas-liquid separation systems may be used in conjunction with the present invention, and one of ordinary skill will be able to determine the most effective system experimentally given these teachings.

An embodiment of the invention herein used a gas pump to pull the hydrogen gas out of both the extractor modules and the electrolyte solution via a hollow fiber membrane-based filter. A Parker Aerospace pump, Model No. T1-1HD-12-1, Cleveland, Ohio, capacity of 32.5 standard liters/minute (SLPM) was used. The bellows-type pump runs at approximately 10V and 1A off its own independent power supply. The pump may deliver the gas to any suitable container for holding flammable gases such as Propane or natural gas. The gas pump used to exert a vacuum on the outlet of the Liqui-Cel filter described above has given good results in removing dissolved gases from the recirculating electrolyte.

### Acoustical Input

The fourth embodiment described the acoustic system, and the same system is utilized in the fifth and sixth embodiments. In all embodiments two specific frequencies of ultrasonic power have been utilized in the single- or multi-cell apparatus. These frequencies are produced by function or frequency generators that are connected to the power lead of the transducers. The function generators also power the transducers-transducers require a minimal power input to drive the signals-3.3 volts @ approx. 35 mA.

The transverse transducer is perpendicular to the anode and produces a frequency of about 38 kHz. The transducer at the bottom of the cell (bottom transducer) produces a frequency of about 76 kHz which is a 1^{st} order harmonic of the bottom transducer frequency. The distance of both transducers from the center of the cathode has been calculated to ensure that both signals meet at the center.

While not intending to be held to any particular theory of operation of any embodiments of the invention, it is currently believed that the transducers operated at these frequencies create cavitation in the aqueous electrolyte region between the cathode and anode; this results in a very chaotic zone where clouds of bubbles are created and destroyed. Given the conditions conductive to bubble creation and implosion, high temperatures and pressures result in the immediate areas around them, generating radical to and high-energy species from water molecules such as H., OH., O. and HO₂. The radicals created result in a highly reactive environment, both oxidative and reductive, with the ultimate release of hydrogen and carbon dioxide from water and the citric acid in the electrolyte. Additional treatment of the chemical theory underlying a possible reaction mechanism is found in U.S. patent application Ser. No. 13/______, filed on even date herewith.

### Electrode Designs

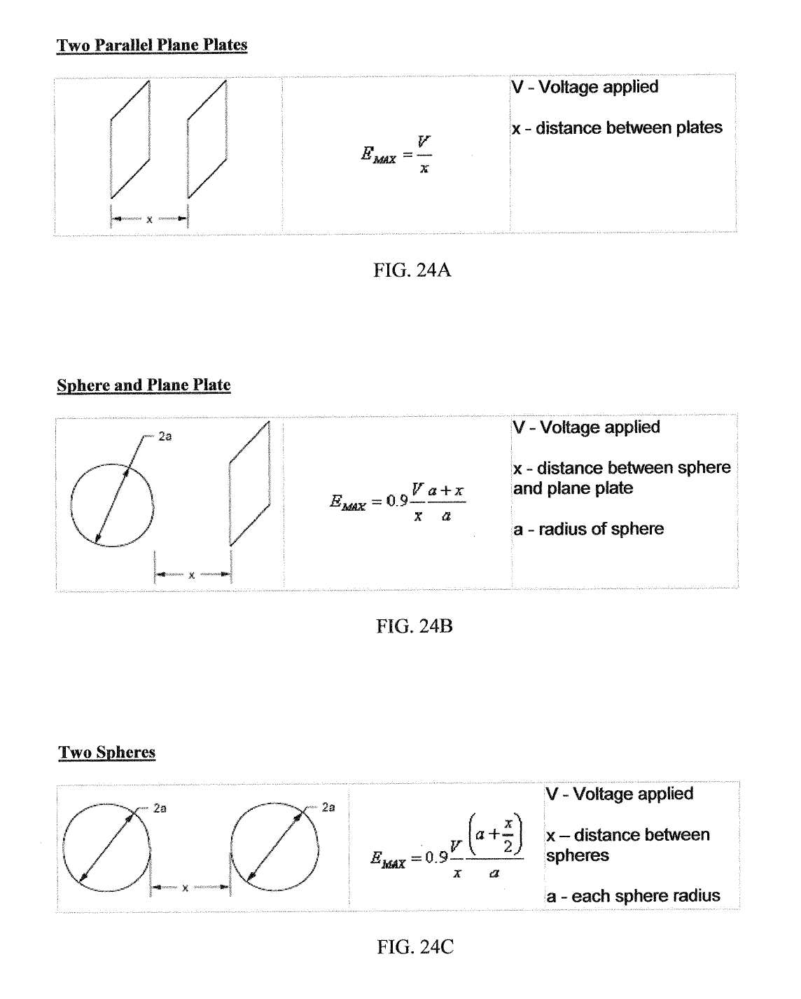

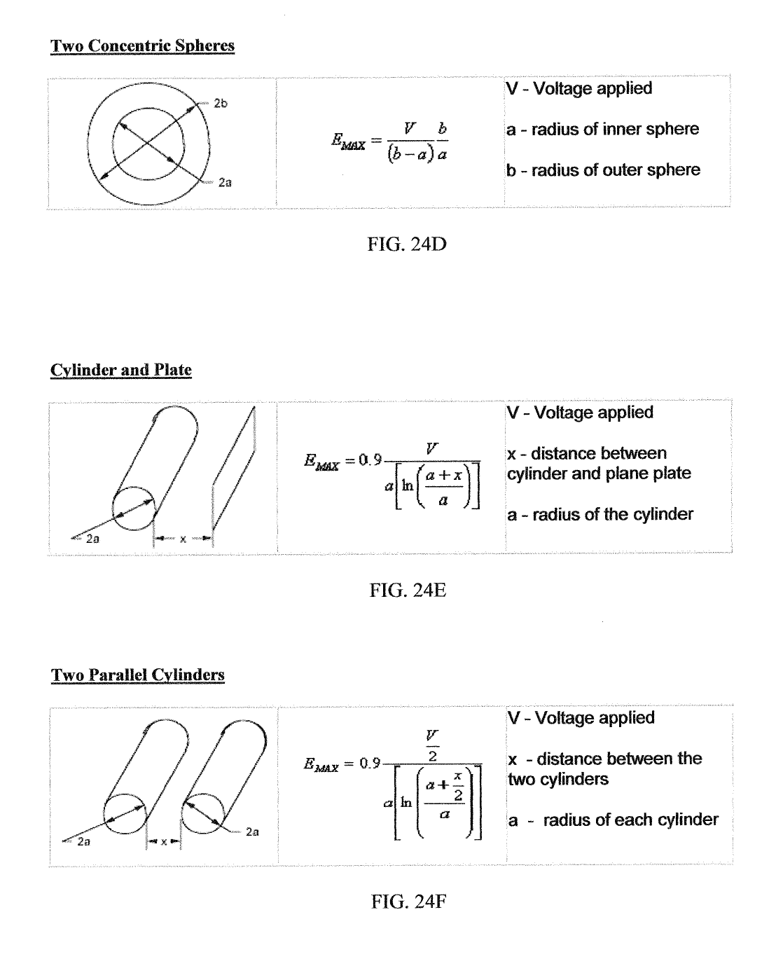

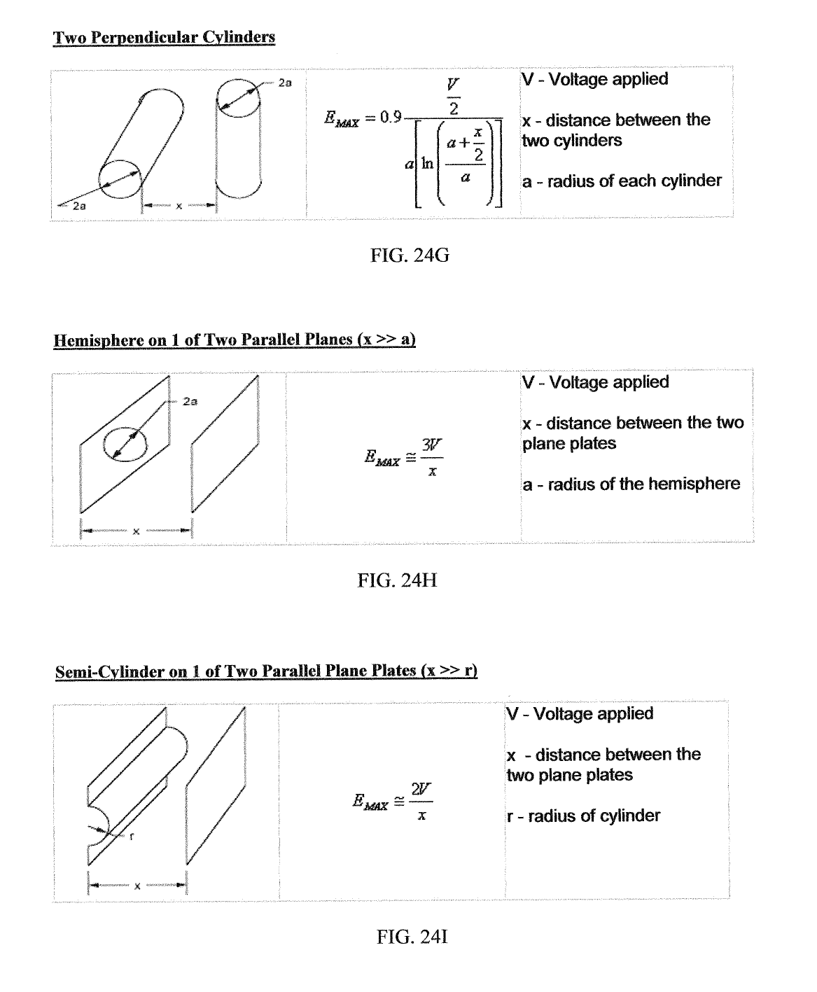

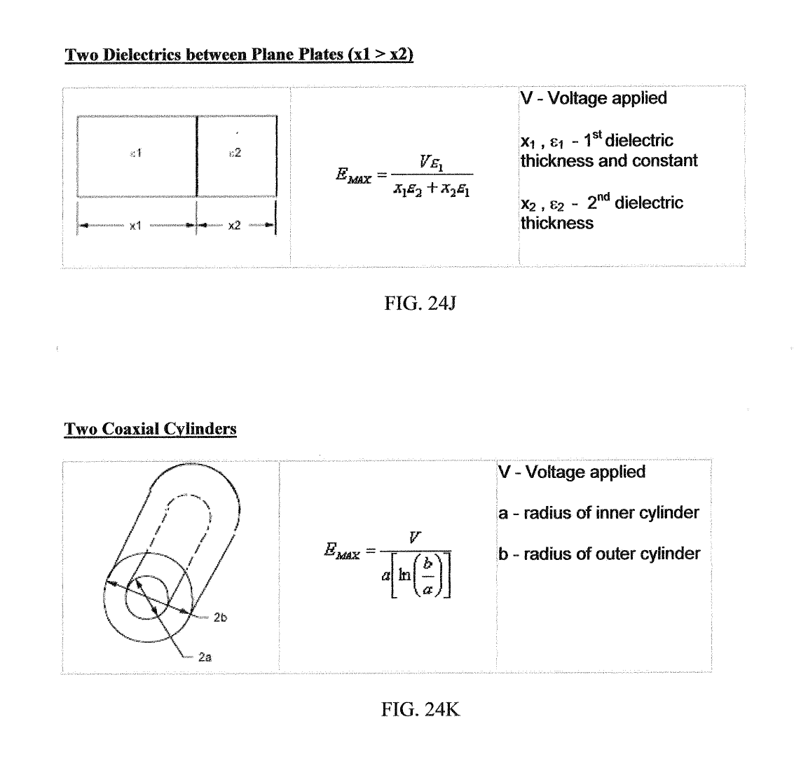

Embodiments of the invention are directed to various electrode designs such as shown in FIGS. 24A-K. One embodiment includes the concentric cylindrical cathode/anode shape because of the electric fields generated when current is introduced into the extractor apparatus. Each cylinder generates predictable and mathematically calculable electric and magnetic field lines, as shown below. The interactions between the field lines generated by the anode and cathode cause the entire region around the cathode to become a reaction zone where hydrogen is produced, as discussed more fully below. Inside the reaction zone, there are areas of high potential and low potential. As electrons in these areas are either promoted or demoted, they yield energy in the form of absorption or emission of photons. It is this energy that helps to promote electron transfer and helps to provide some of the energy necessary to run the reactions that break down the organic acids and produce hydrogen.

The cylindrical shapes and the resulting fields allow us to create a volumetric phenomenon, rather than a surface-mediated phenomenon such as electrolysis. A surface-mediated phenomenon typically cannot be accelerated without increasing the number of reaction sites, i.e. increasing surface area. In this invention, the entire volume around the cathode becomes the reaction chamber. This is shown when a volume-specific reaction is created, versus a surface only reaction.

FIGS. 24A-K contain charts of shape versus field possible electrode geometries. For the example of two concentric fields, the electric fields interact according to the following theory.

For an electrolyte solution in an electrochemical cell having a cathode wire located coaxial with a concentric anode tube, with steady (DC) currents and voltages, no local distribution will develop, so the Laplace Equation describes the potential V as

∇²V=0 (1)

subject to boundary conditions, which are well specified on the surfaces of the electrodes but more poorly defined on other surfaces of the cell. Then the electric field E is

E=−∇V (2)

and the current density J as a function of field or potential is

J=∫σE=−σ∇V (3)

The total current flowing through any surface is the flux of the current density

I=∫JdA. (4)

The external circuit may limit the current flowing through the solution, thus limiting J, E, and the total voltage drop, ΔV. In the case of infinitely long concentric cylinders with radii a and b, and a potential difference, ΔV, Laplace's equation yields potential as a function of the radial coordinate,

$$V ( r ) = \frac{Δ V ln ( r )}{ln ( b / a )} . \qquad ( 5 )$$

Then the electric fields is

$$E = - \frac{d V}{d r} = - \frac{Δ V}{r ln ( b / a )} , \qquad ( 6 )$$

and the current density is

$$J = σ E = - σ \frac{Δ V}{r ln ( b / a )} . \qquad ( 7 )$$

Thus the total current per unit length of the cylinders is

$$\frac{2 π σΔ V}{ln ( b / a )} . \qquad ( 8 )$$

Therefore, the maximum electric field is near the inner cylinder (cathode) at r=a:

$${E}_{max} = \frac{Δ V}{a ln ( b / a )} \qquad ( 9 )$$

The field is thus seen to be very different and tunable from the standard two flat plate configuration.

The electrical conductivity of a solution may vary with time and location. In a weakly conducting medium, if the maximum local electric field is strong enough, dielectric breakdown may occur, freeing more mobile charge carriers and thus increasing the conductivity in a small region for a shirt time. Free ions may bond into more weakly ionic species, thus lowering conductivity. Gas bubbles that form may block current flow temporarily. If these variations in conductivity occur on time scales that are fast compared to the relaxation for the bulk medium (τ), charge density (ρ) may accumulate. Then the potential will be described by Poisson's Equation:

$${∇}^{2} V = - \frac{ρ}{ɛ} . \qquad ( 10 )$$

As charge density will vary rapidly with time and position in a liquid, the system becomes more complex.

Inside the solution between the two concentric cylinders (FIG. 24K) an area we will call the “reaction zone” can be observed close to, but not on, the inner cylinder. In this zone, reactions involving gas evolution can be seen by the naked eye. The volume, v, of the reaction zone inside the solution can be found by observing the inner radius, rᵢ, and an outer radius, rₒ, of the reaction. Let the distance between these two radii be, dr.

v=πh(rₒ²−rᵢ²) (11)

where h is the height of the cylinders. The mass, m, of the solution inside the reaction zone can be found with the density of the solution, ρ,

m=vρ. (12)

With the mass of the cylinder we can find the number of moles, n, with the molecular mass, M, of the solution,

$$n = \frac{m}{M} . \qquad ( 13 )$$

From the number of moles we can find the number of molecules with Avogadro's constant,

n(6.02*10²³ molecules/mole). (14)

The electric field of the reaction zone inside the solution is the sum of all the electric fields at each radius, or the integral of the electric field over the volume of the reaction zone.

$$E = \frac{Q ln ( {r}_{o} / {r}_{i} )}{2 π L ɛ} \qquad ( 15 )$$

The maximum electric field occurs just outside the inner cylinder and decreases as it moves away from the inner cylinder. In experimentally observing the reaction zone, however, it does not start right outside the inner cylinder but is displaced a measurable distance away from the cylinders surface. This may be because the reaction only can occur in a certain range of electric field strength,

Eₘᵢₙ≦E_{reaction}≦Eₘₐₓ, (16)

We observed the reaction occurring at a large electric field but not necessarily at the maximum electric field. Another factor in determining the reaction zone may be due to the current density inside the solution, having the reaction occur only between certain current densities,

Jₘᵢₙ<J_{reaction}<Jₘₐₓ (17)

or

σEₘᵢₙ<J_{reaction}<σEₘₐₓ, (18)

which is also dependent on a certain maximum reactive electric field and a minimum reactive electric field. This phenomenon may also be explained by ‘ionic acceleration’ in the liquid, where the particles must reach a certain speed before the reaction can occur. This idea can be compared to the “dark region” that occurs during plasma discharge.

Given these teachings, one of ordinary skill may adapt other of the electrode geometries disclosed in FIGS. 24A-K disclosed to hydrogen production in similar sonoelectrochemical apparati. Provisional patent application 61/501,529 filed Jun. 27, 2011 is incorporated herein by reference in its entirety.

As previously described under the fourth embodiment, a BK Precision 3-Channel programmable power supply has been used to power the extractors. This is a DC output power supply with a limit of 30 Volts and 3 Amps per channel. It is possible to run channels 1 and 2 in parallel, thereby achieving a 6 Amp current. Channels 1 and 2 are generally set with a current of 3 Amps and a voltage ceiling of 30 Volts. As the system runs, it is able to pull as much voltage as it requires up to 30 Volts.

The system resembles a capacitor in that the electrolysis cell's two electrodes are separated by a dielectric that is able to hold some amount of current for a finite period. However, the system is complicated by the somewhat changeable resistive pathway due to the changing nature of the electrolyte. Added to that is the effect of acoustic cavitation, which adds reactive species to the electrolyte too. The electrolyte component NaCl is the primary charge carrier, and its concentration remains relatively constant. However, in various embodiments the hydrocarbon component, such as citric acid, is a tricarboxylic acid at about 0.1M which also contributes some charge carrying capacity. As the citric acid is consumed, the effective charge density of the electrolyte decreases and the cell's voltage and amperage will fluctuate in response.

### Systems for Generating Electricity

It will be understood by those of ordinary skill in the art of hydrogen generation that a source of hydrogen producible “on demand” may be mated to any thermo- or electrochemical system for converting Hydrogen's chemical potential energy into any one of numerous useful forms of energy. For example, rocket engines produce thrust by combining liquefied hydrogen and oxygen in a combustion chamber, thereby releasing the enormous energy of the H₂+O₂ reaction (286 kJ/mole). In addition to rocket engines, hydrogen is a gas at standard temperature and pressure and can be used in a manner similar to methane, propane or natural gas, that is, it can be burned solely or as a supplementary fuel to power boilers to make electricity. Industrial scale boilers have been fitted to burn hydrogen such as by Coen Company. Hydrogen can also be used directly in Hydrogen Fuel Cells to make electricity. Hydrogen can also be used to power cars such as Honda's FCX CLARITY, a hydrogen fuel cell-powered electric vehicle, or in internal combustion engines modified to run on Hydrogen such as BMW's Hydrogen 7 car (H-ICE). In fact, any form of modern transportation that uses electricity or internal combustion is a candidate for conversion to a hydrogen-based energy source.

Although a specific embodiment of the invention has been disclosed, it will be understood by those having skill in the art that changes can be made to this specific embodiment without departing from the spirit and scope of the invention. Likewise, it will be understood by those having skill in the art that the teachings herein can be scaled in size to increase or decrease hydrogen production without affecting the scope and spirit of the present invention. The scope of the invention is not to be restricted, therefore, to the specific embodiments, and it is intended that the appended claims cover any and all such applications, modifications, and embodiments within the scope of the present invention.

### PARTS

### I. 4^{th} Embodiment

500 sonoelectrolytic cell—fourth embodiment
510 Base support plate
512 upper anode support plate
513 spacer supports
514 gas collection tube support plate
515 gas collection tube
516 notch
520 anode
522 anode lead
525 lower anode support plate
526 stepped cutout
527 tie rod
528 nuts
530 cathode
532 cathode lead
533 copper mesh
540 bottom transducer
541a terminal
541b terminal
542 bottom transducer lead
543 split ring
544 bottom transducer housing cap
545 mesh
546 bottom transducer housing base
550 transverse transducer
551 mesh
552 transverse transducer lead
553 transverse transducer housing cap
555 transverse transducer support plate

### II. 5^{th} Embodiment

600 sonoelectrolytic cell—fifth embodiment
605 box
606 bottom
610 lid
615 gas collection tube
616 slots
617 gas collection tube adapter
618 filter housing
619 MPT adapter
620 cathode—bottom transducer unit
621 cathode housing lid
622 cathode housing
623 mesh
624 split ring
625 bottom transducer housing
626 transverse transducer lid
627 mesh
628 split ring
629 transverse transducer housing
650 transverse transducer unit
660 tank.

### III. 6^{th} Embodiment

700 six-cell extractor
710 base support plate
712 upper anode support plate
715 gas collection tube
720 anode
725 lower anode support plate
730 cathode
750 Gas Collection Apparatus
755 transverse transducer support plate
757 cell separators
760 membrane/filter unit
761 lower filter housing
762 support
763 membrane/filter
764 upper filter housing
765 membrane/filter top
768 manifold
770 manifold base
772 male pipe adapters
774 Y-adapter
776 lower filter housing
778 lip
780 membrane
782 nylon mesh
784 O-ring
786 upper filter housing
790 manifold top
792 male pipe adapter

We claim:

1. Apparatus for producing hydrogen gas comprising:
a container adapted to contain an aqueous electrolyte solution containing hydrogen;
at least one first electrode, wherein said at least one first electrode is adapted to be in contact with a solution;
at least one second electrode, wherein said at least one second electrode is adapted to be in contact with a solution;
wherein the at least one first electrode is a cylindrically-shaped cathode and the at least one second electrode is a cylindrically-shaped hollow anode capable of accommodating the cylindrically-shaped cathode within it, and wherein the cylindrically-shaped cathode is located along the central axis of the cylindrically-shaped hollow anode;
at least a first acoustic transducer per cathode capable of causing cavitation in a solution, said at least one first transducer transmitting substantially along each cathodic axis;
a power supply wherein power is supplied to the electrodes and transducers;
a wave form generator for imposing a wave or other function on the power to the transducers; and
a gas-liquid separation and capturing device.

2. The apparatus of claim 1 additionally comprising at least a second acoustic transducer per anode and wherein the first and second acoustic transducers are capable of causing cavitation in an aqueous solution, said first transducer transmitting substantially along the cathodic axis, and said second transducer transmitting in a substantially orthogonal direction to the first transducer.

3. The apparatus of claim 2 wherein the first transducer transmits at an acoustic frequency of about 38 kHz and the second transducer transmits at about 76 kHz.

4. The apparatus of claim 1 wherein the gas-liquid separation and capturing device is selected from the group consisting of a tube, a membrane filter, a diffusive evaporator, differential pressure and channeling solution flow.

5. The apparatus of claim 4 wherein the tube has a different dielectric than that of the surrounding solution and is located between the anode and cathode.

6. The apparatus of claim 5 wherein the tube surrounds the cathode and contains and guides gas bubbles to the gas separation and capturing device.

7. The apparatus of claim 4 wherein the tube has a gas-permeable polymer membrane filter disposed within its length.

8. The apparatus of claim 4 wherein the gas-liquid separation device comprises a hollow fiber membrane filter.

9. The apparatus of claim 4 wherein the gas-liquid separation device comprises an expansion tank.

10. The apparatus of claim 1, wherein the container contains an aqueous electrolyte solution that comprises an effective amount of dissolved noble gas.

11. The apparatus of claim 10 wherein the aqueous electrolyte solution comprises an iodide salt or an iodate salt.

12. The apparatus of claim 10 wherein the container contains an aqueous electrolyte solution that comprises an iodide salt or an iodate salt and the solution further comprises up to and including 5% noble gas dissolved in the solution.

13. The apparatus of claim 10 wherein the container contains an aqueous electrolyte solution comprising one or more organic acids.

14. The apparatus of claim 1 wherein the wave form is a sine wave.

15. The apparatus of claim 2 wherein the individual waveforms from the first and second transducers collide in the region between the cathode and anode.

16. The apparatus of claim 1 wherein the cathode and anode are arranged in pairs.

17. The apparatus of claim 1 wherein more than one cathode may be matched with a single anode.

18. The apparatus of claim 1 additionally comprising an electrolyte recirculation circuit.

19. The apparatus of claim 18 additionally comprising a nozzle for directing electrolyte fluid towards the cathode.

20. A system for generating electricity comprising the apparatus of claim 1 in combination with one of an electrical generator, a fuel cell, and a hydrogen-burning internal combustion engine.
